(19) United States
(12) Patent Application Publication
(10) Pub. No.: US 2016/0063516 A1
(43) Pub. Date: Mar. 3, 2016

(54) METHODS AND APPARATUS TO ESTIMATE COMMERCIAL CHARACTERISTICS BASED ON GEOSPATIAL DATA

(71) Applicant: The Nielsen Company (US), LLC, Schaumburg, IL (US)

(72) Inventors: Alejandro Terrazas, Santa Cruz, CA (US); Paul Donato, New York, NY (US); Peter Lipa, Tucson, AZ (US); Michael Sheppard, Brookline, MA (US); Wei Xie, Woodridge, IL (US); Caroline McClave, Brooklyn, NY (US); David Miller, Annandale, VA (US)

(21) Appl. No.: 14/473,646

(22) Filed: Aug. 29, 2014

(51) Int. Cl. G06Q 30/02; G06K 9/62; G06K 9/46; G06K 9/00; G06T 7/40

(52) U.S. Cl. CPC G06Q 30/0201; G06K 9/00476; G06T 7/408; G06K 9/4652; G06K 9/6215; G06T 7/40

(57) ABSTRACT

Methods and apparatus to estimate commercial characteristics based on aerial images are disclosed. An example method includes identifying, using a computer vision technique, a feature in a first aerial image of a geographic location of interest, identifying a reference aerial image that includes the feature from a set of reference aerial images, the reference aerial image being associated with commercial characteristics, and associating a first one of the commercial characteristics with the location of interest.

### FIELD OF THE DISCLOSURE

This disclosure relates generally to commercial surveying, and, more particularly, to methods and apparatus to estimate commercial characteristics based on geospatial data.

### BACKGROUND

Manufacturers and/or distributors of goods and/or services sometimes wish to determine where new markets are emerging and/or developing. Smaller, growing markets are often desirable targets for such studies. As these markets grow larger and/or mature, previous market research becomes obsolete and may be updated and/or performed again.

### BRIEF DESCRIPTION OF THE DRAWINGS

FIG. 1 is a block diagram of an example system constructed in accordance with the teachings of this disclosure to estimate commercial characteristics of a commercial point of interest or commercial area of interest based on geospatial data.

FIG. 2 is a block diagram of an example implementation of the example feature identifier of FIG. 1.

FIG. 3 is a block diagram of an example implementation of the example color feature analyzer of FIG. 2.

FIG. 4 is a block diagram of an example implementation of the example image comparator of FIG. 1.

FIG. 5 illustrates an example collection of aerial images including and surrounding a first example commercial point of interest, from which the system of FIG. 1 may determine contextual features to determine a commercial ecosystem of the first commercial point of interest.

FIG. 6 illustrates an example closest-matching reference image to the aerial image of FIG. 5 in a reference database determined by the example system of FIG. 1.

FIG. 7 is a flowchart representative of example machine readable instructions which may be executed to implement the example system of FIG. 1 to estimate commerce characteristics of a commercial point of interest.

FIGS. 8A and 8B collectively illustrate a flowchart representative of example machine readable instructions which may be executed to implement the example feature identifier of FIG. 1 to identify contextual features present in an aerial image of a commercial point of interest.

FIG. 9 is a flowchart representative of example machine readable instructions which may be executed to implement the example image comparator of FIG. 1 to identify one or more reference aerial images having contextual features identified in an aerial image of a commercial point of interest.

FIG. 10 is a flowchart representative of example machine readable instructions which may be executed to implement the example point/area of interest classifier of FIG. 1 to estimate commerce characteristics of an identified reference aerial image.

FIG. 11 is a flowchart representative of example machine readable instructions which may be executed to implement the example image comparator of FIG. 1 to identify one or more reference aerial images having contextual features identified in an aerial image of a commercial point of interest.

FIG. 12 is a flowchart representative of example machine readable instructions which may be executed to implement the example color feature analyzer of FIGS. 2 and/or 3 to determine color features of reference images for comparison with color features of an aerial image.

FIG. 13 is a flowchart representative of example machine readable instructions which may be executed to implement the example color feature analyzer of FIGS. 2 and/or 3 to identify color features of an aerial image.

FIG. 14 is a flowchart representative of example machine readable instructions which may be executed to implement the example color feature analyzer of FIGS. 2 and/or 3 to identify reference images based on a color feature of an aerial image.

FIGS. 15A-15E illustrate example representations of aerial images of that have been converted to representative colors based on the features in the aerial images.

FIG. 16 is a block diagram of an example processor platform capable of executing the instructions of FIGS. 7, 8A-8B, 9, 10, 11, 12, 13, and/or 14 to implement the example image analyzer, the example image comparator, and/or the example point/area of interest classifier of FIGS. 1, 2, 3, and/or 4.

The figures are not to scale. Wherever appropriate, the same reference numbers will be used throughout the drawing(s) and accompanying written description to refer to the same or like parts.

### DETAILED DESCRIPTION

Examples of commercial points of interest (cPOIs) include retail malls, retail stores, wholesale merchants, discount clubs, and/or street corners. Examples of commercial areas of interest (cAOIs) include blocks and/or neighborhoods. These examples of cPOIs and cAOIs are intended to provide a sense of scale for the terms cPOI and cAOI, and are not intended to be limiting. In some examples, cAOIs include additional contextual features not possessed with cPOIs, such as the shape of an area or object associated with the cAOI. For clarity and brevity, the term “point of interest” is used to indicate a relatively small area of interest that could be considered as a geographic point (e.g., an intersection of two roads, a street corner, a landmark, etc.). As used herein, the term “area of interest” is used to indicate an area larger than a point of interest. An area of interest may include one or more points of interest. As used herein, the term “location of interest” is used to refer to an area of interest (e.g., a cAOI) or a point of interest (e.g., a cPOI).

A cPOI or a cAOI, does not exist in isolation. Instead, the area surrounding the cPOI and/or cAOI influences the cPOI and/or cAOI, such that the cPOI and/or cAOI exists in a commercial ecosystem. As used herein, the term “commercial context” is defined to refer to the types of building uses and/or activities occurring in the area(s) surrounding the cPOI and/or cAOI. A commercial context may be determined for any radius around the cPOI and/or cAOI. The radius may be selected so that contextual features within the selected area accurately indicate the commercial ecosystem of the cPOI and/or cAOI. As used herein, the term “commercial ecosystem” is defined to refer to a co-existence of one or more commercial establishments and the interrelationships (whether intended or unintended) existing between the establishments. The area for which a commercial context is determined may be, but is not necessarily, centered on the cPOI and/or cAOI. Furthermore, the area for which a commercial context is determined may be any desired shape and/or measured in any desired units (e.g., metric units, imperial units, city blocks, etc.).

Examples disclosed herein use the context of the cPOI and/or cAOI, such as the features and/or characteristics of the surrounding areas, to understand and/or characterize the commercial ecosystem of the cPOI and/or cAOI. For example, all malls are not the same. A first mall near the edge of a large green space often has different offerings (e.g., different stores and/or services) than a second mall in the center of a major mixed-residential area. As another example, retail and/or other commercial buildings near wealthier homes are usually different than retail and/or other commercial buildings found near poorer homes and/or those found near industrial areas.

Example methods and apparatus disclosed herein identify and compare contextual features to differentiate cPOIs/cAOIs from other cPOIs/cAOIs that appear similar (especially as seen from an aerial or satellite image). By differentiating cPOIs/cAOIs that appear similar, example methods and apparatus disclosed herein may be used to identify cPOIs/cAOIs that have very similar commercial ecosystems and/or for characterizing the commercial ecosystems of geographic areas without physically surveying or sampling the areas (e.g., without the cost of having humans at the area, without boots on the ground).

Some examples disclosed herein characterize a commercial ecosystem of a cPOI or cAOI using aerial (e.g., satellite) images. As used herein, the term “aerial image of interest” refers to aerial images that include a cPOI and/or cAOI and/or to aerial images of areas associated with (e.g., nearby) but not including the cPOI and/or cAOI. Example methods and apparatus disclosed herein identify contextual features present in an aerial image of the cPOI and/or cAOI (and/or images of locations surrounding the cPOI and/or cAOI).

Examples disclosed herein detect some types of contextual features using computer vision techniques. For example, public parks often have characteristic patterns (e.g., green grass, certain size, etc.), while land used for farming often has different characteristic patterns (e.g., dirt or crops, larger size, certain textures, crop circles, etc.). While parks and farm land often do not have characteristic shapes, buildings and/or other manmade contextual features are often identifiable by shape. Roads are often identifiable by length, straightness, and/or the ratio of length to width. Many features and/or combinations of features that are identifiable using computer vision in an aerial image also provide context information to characterize a cPOI and/or a cAOI.

Example methods and apparatus disclosed herein select an aerial image of the cPOI and/or cAOI, and/or an aerial image of an area near the cPOI and/or cAOI, for comparison to reference aerial images in a reference database. Example methods and apparatus disclosed herein perform matching on the reference aerial images (e.g., using images in the reference database). Examples disclosed herein compare identified contextual features of the aerial image to contextual features of reference aerial images of reference locations in a reference database. Aerial images in the example database are aerial images of reference points and/or reference areas. In some examples, the reference database is updated with new reference points and/or reference areas and/or new information for reference points and/or reference areas that are already represented in the reference database. In some examples, the reference database is periodically and/or aperiodically pruned to remove redundant points and/or areas.

The reference database returns a set of candidate matches (e.g., 1 to N number of matches) by comparing contextual features of the aerial image with contextual features of the selected reference image. In some examples, information that is extraneous to the aerial images (e.g., supplemental data such as other point of interest data, traffic data, and/or any other type of geospatial data, etc.) is also used to determine and/or refine the list of matching images.

When one or more reference images are identified as matching an aerial image of interest, disclosed examples estimate the commercial ecosystem of the point and/or area of interest (e.g., cPOI and/or cAOI) based on the commercial ecosystems of the reference location(s) of the matching reference image(s). The commercial ecosystems of the reference locations are known to the matching system based on, for example, manual surveying of the commercial ecosystems performed at the reference locations. In some examples, the reference aerial images are associated with the “ground truth” for the commercial ecosystems of the associated points and/or areas. Examples disclosed herein describe commercial ecosystems in terms of type(s) of (a) nearby commerce (e.g., mall, market, sequence of roadside buildings, etc.), (b) an “all commodity volume” (ACV) of the commercial locations and/or the cPOI and/or cAOI as a whole, (c) the consumer segment(s) (e.g., luxury retail, economy goods, etc.), and/or (d) types of goods (e.g., prepared food, grocery, home goods, luxury items, etc.) served at the cPOI and/or cAOI. Examples disclosed herein characterize the commercial ecosystem of the cPOI and/or cAOI based on the commercial ecosystem and/or commercial characteristics of the reference image(s) found to match the aerial image of the cPOI and/or cAOI (e.g., reference aerial images that included same or similar sets of contextual features).

In some examples, the aerial image(s) of a street corner (e.g., a cPOI) and/or the surrounding area (e.g., a cAOI) are analyzed (e.g., using computer vision techniques) to determine features such as 1) a city park that is two kilometers from the street corner, 2) a major highway (e.g., more than X cars per day) that is two city blocks from the street corner, and/or 3) a train station that is approximately 0.2 kilometers from the street corner. Example methods and apparatus disclosed herein use computer vision, alone or in combination with supplemental data (e.g., data not obtained from the aerial image), to extract or identify the features in the aerial image. Example methods and apparatus disclosed herein query a reference database of reference aerial images to identify points and/or areas having similar sets of features, some or all of which may be at similar distances from the cPOI or cAOI). In some examples, the query is limited to images associated with a same type of point and/or area of interest (e.g., street corners) as the cPOI and/or cAOI under investigation.

After identifying the reference aerial images, some such examples determine the commercial characteristics associated with those aerial images (e.g., from the reference database), and apply one or more of the commercial characteristics from the reference database to the cPOI and/or cAOI of interest (e.g., the street corner of the example). This information may be used to evaluate the prospects for selling/offering one or more goods or services at that location (e.g., the cPOI and/or cAOI).

Computer vision is a technical field involving processing digital images in ways that mimic human processing of images. Disclosed example methods and apparatus solve the technical problems of accurately categorizing and/or matching aerial images using combinations of computer vision techniques and/or other geospatial data. Disclosed example techniques use computer vision to solve the technical problem of efficiently processing large numbers of digital images to find an image that is considered to match according to spatially-distributed sets of features within the image.

Example methods disclosed herein include identifying a feature in a first aerial image of a geographic location of interest, identifying a reference aerial image that includes the feature from a set of reference aerial images, the reference aerial image being associated with commercial characteristics, and associating a first one of the commercial characteristics with the location of interest.

In some example methods, the identifying of the feature includes using computer vision to identify the feature based on at least one of a shape of an object in the first aerial image, a color in the first aerial image, a texture in the first aerial image, a count of objects in the first aerial image, or a density of objects in the first aerial image. In some examples, the identifying of the feature further includes identifying at least one of a public park in the first aerial image, a building having a designated type in the first aerial image, a road in the first aerial image, a transportation feature in the first aerial image, a count of observed vehicles in the first aerial image, a vehicle parking area in the first aerial image, a fueling station in the first aerial image, a residential area in the first aerial image, a commercial area in the first aerial image, or a daytime employment area in the first aerial image.

In some example methods disclosed herein, the identifying of the feature includes using computer vision and at least one of mapping service data, public real estate record data, traffic monitoring data, and/or mobile communications data to identify the feature. In some such example methods, the identifying of the reference aerial image is based on identifying the reference aerial image as having the second feature. In some such examples, the second feature includes at least one of an urbanicity, a walkability, a driving score, or daytime employment.

In some examples, the identifying of the feature includes generating a modified aerial image by modifying pixel colors of the first aerial image based on a surjective map of colors and calculating a color distribution of the modified aerial image. In some such examples, the identifying of the reference aerial image further includes comparing a divergence metric to a threshold, the divergence metric based on the color distribution of the modified aerial image and a color distribution determined based on the reference aerial image and the surjective map of colors. As used herein, a surjective map refers to a function fin which, for a set A and a set B, for any b in B (bεB) there exists an a in A (aεA) for which b=f(a).

Some example methods disclosed herein further include weighting the feature based on a type of the feature. In some such examples, the identifying of the reference image is based on the weight of the feature. In some example methods, the identifying of the reference aerial image further includes querying a reference database after identifying the feature. In some such examples, the reference database includes sets of features associated with respective images of the set of reference aerial images. Some example methods disclosed herein further include determining whether the reference aerial image matches the first aerial image based on a comparison of a first set of features of the first aerial image to a second set of features of the reference aerial image, the first set of features including the first feature. In some such examples, the associating of the first one of the commercial characteristics with the location of interest is in response to determining that the reference aerial image matches the first aerial image.

Example apparatus disclosed herein include a feature identifier to identify a first feature in a first aerial image of a geographic area including a location of interest, an image comparator to identify a reference aerial image from a set of reference aerial images, the reference aerial images including the first feature and being associated with commercial characteristic, and a classifier to associate the commercial characteristic with the location of interest.

In some example apparatus disclosed herein, the feature identifier comprises a computer vision analyzer to identify the feature using computer vision. In some such examples, the feature identifier further includes a derived feature calculator to identify a second feature associated with the first aerial image based on the first feature and supplemental data associated with the geographic area. In some such example apparatus, the second feature comprises at least one of an urbanicity (e.g., a measure of the degree of which an area is urban), a walkability, a driving score, or daytime employment.

In some example apparatus disclosed herein, the first feature is at least one of a public park in the first aerial image, a building having a designated type in the first aerial image, a road in the first aerial image, a transportation feature in the first aerial image, a count of observed vehicles in the first aerial image, a vehicle parking area in the first aerial image, a fueling station in the first aerial image, a residential area in the first aerial image, a commercial area in the first aerial image, or a daytime employment area in the first aerial image.

In some examples, the feature identifier includes a feature weighter to apply a weight to the first feature based on a type of the first feature. In some such examples, the feature identifier further includes a distance meter to determine a distance between the first feature and the location of interest based on a scale of the aerial image, the feature weighter to apply the weight to the first feature based on the distance.

In some example apparatus disclosed herein, the feature identifier includes a color feature analyzer to identify the first feature based on colors present in the aerial image. In some such examples, the color feature analyzer includes an image color reducer to map the colors in the aerial image to a surjective color map including mapped colors. The color feature analyzer of some such examples determines the first feature based on the mapped colors. In some examples, the color feature analyzer includes a color distribution generator to generate a probability distribution of colors associated with the aerial image. In some such examples, the color feature analyzer further includes a comparison metric calculator to calculate a similarity value based on a divergence of the probability distribution associated with the aerial image and a second probability distribution associated with the reference aerial image.

In some example apparatus, the color feature analyzer includes a color balancer to adjust the colors present in the aerial images based on at least one of a time of year during which the aerial image was captured or a geographic area corresponding to the image. In some examples, the image comparator includes a query generator to generate a query to query the set of reference aerial images, the query generator to generate the query based on the first feature (or metadata associated with the feature). In some example apparatus, the image comparator includes a feature comparator to compare a first set of features of the first aerial image to a second set of features of the reference aerial image, the first set of features including the first feature, and a match score calculator to determine whether the reference aerial image matches the first aerial image based on a comparison of the first set of features to the second set of features.

Other example methods disclosed herein include generating a representation of an aerial image of a geographical area based on colors present in the aerial image, identifying an image in a database of reference aerial images that most closely matches the aerial image based on a selected metric, and determining a characteristic of the geographical area based on a known characteristic associated with the identified image. In some example methods, generating the representation of the aerial image includes modifying pixels in the aerial image to conform to a color mapping containing a first set of colors containing fewer colors than a set of unique colors present in the reference aerial images in the database, and generating a color distribution of the aerial image using the first set of colors. In some examples, identifying the image that most closely matches the aerial image comprises determining a divergence metric between the identified image and the aerial image.

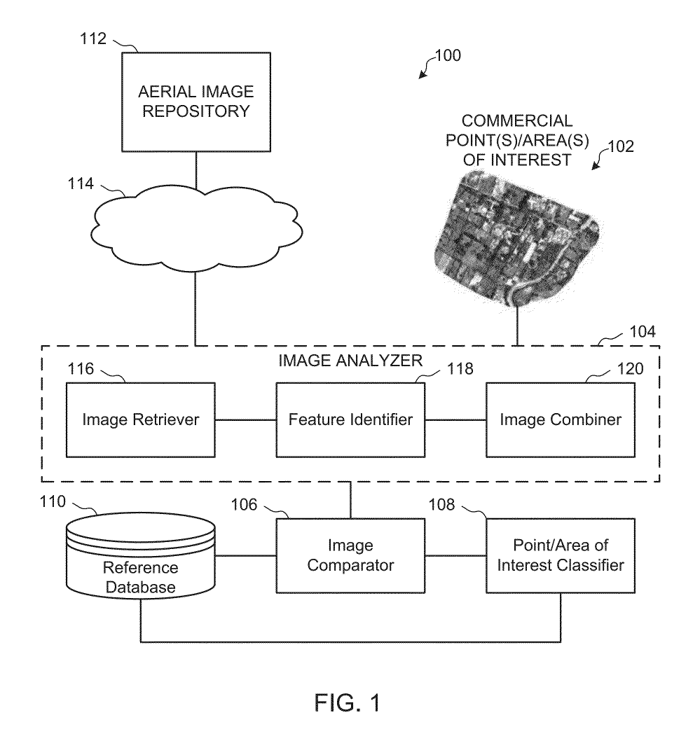

FIG. 1 is a block diagram of an example system 100 to estimate commercial characteristics of a cPOI or cAOI based on aerial images. In the example of FIG. 1, the system 100 receives data (e.g., GPS coordinates, an aerial image, etc.) identifying a point and/or area of interest 102 (e.g., a cPOI and/or a cAOI) for analysis. To estimate the commercial characteristics (e.g., the commercial ecosystem) of the area and/or point of interest 102, the example system 100 compares an aerial image of the area and/or point of interest 102 to reference images of reference areas. In the example of FIG. 1, the commercial characteristics of the reference areas are known. The example system 100 of FIG. 1 imputes or applies commercial characteristics to the area and/or point of interest 102 corresponding to reference areas that have features demonstrating similar commercial contexts (e.g., sets of contextual features) as the area and/or point of interest 102.

The example system 100 of FIG. 1 includes an image analyzer 104, an image comparator 106, a point/area of interest classifier 108, and a reference database 110. The example image analyzer 104 identifies contextual features present in the aerial image of the area and/or point of interest 102. In some examples, the image analyzer 104 further determines contextual features present in aerial images of areas surrounding the area and/or point of interest 102. For example, some areas surrounding the area and/or point of interest 102 may be represented by separate, individual images. In some other examples, the areas surrounding the area and/or point of interest 102 may be included in the same aerial image as the area and/or point of interest 102. The division of images may be based on the resolution of the images (e.g., whether the image at a particular level of zoom has sufficient detail to identify contextual features with sufficient accuracy).

The example image analyzer 104 of FIG. 1 obtains aerial images from an aerial image repository 112. The example aerial image repository 112 of FIG. 1 provides aerial and/or satellite image(s) of specified geographic areas (e.g., the area and/or point of interest 102 and/or surrounding areas) to a requester that identifies those areas (e.g., via a network 114 such as the Internet). The example images may include aerially-generated images (e.g., images captured from an aircraft) and/or satellite-generated images (e.g., images captured from a satellite). The images may have any of multiple sizes and/or resolutions (e.g., images captured from various heights over the geographic areas). Example satellite and/or aerial image repositories that may be employed to implement the example aerial image repository 112 of FIG. 1 are available from DigitalGlobe®, GeoEye®, RapidEye, Spot Image®, and/or the U.S. National Aerial Photography Program (NAPP). The example aerial image repository 112 of the illustrated example may additionally or alternatively include geographic data such as digital map representations, source(s) of population information, building and/or other man-made object information, and/or external source(s) for parks, road classification, bodies of water, etc.

The example image analyzer 104 of FIG. 1 analyzes aerial images of interest to identify contextual features that may be used to identify similar commercial contexts based on the aerial images of those commercial contexts. The image analyzer 104 of the illustrated example includes an image retriever 116, a feature identifier 118, and an image combiner 120. The example image retriever 116 of FIG. 1 receives an indication of the area and/or point of interest 102 (e.g., coordinates, a description, etc.).

From the indication of the area and/or point of interest 102, the example image retriever 116 identifies the location of the area and/or point of interest 102 and requests an aerial image of the area and/or point of interest 102. For example, the image retriever 116 may interpret a text description of the area and/or point of interest 102 (e.g., “the northeast corner of State street and Madison street in Chicago, Ill., USA”) to a coordinate system (e.g., GPS coordinates “41.882058, −87.627808”) or other system used by the aerial image repository 112 to identify aerial images.

The image retriever 116 of the illustrated example further determines a surrounding area from which contextual features are to be identified for the area and/or point of interest 102. For example, the image retriever 116 may determine a radius for the area and/or point of interest 102 depending on the size of the area and/or point of interest 102 (or area of interest), a size of the area in which the area and/or point of interest 102 is located (e.g., a size of the municipality), a type of the area in which the area and/or point of interest 102 is located (e.g., a “college town” in which a relatively large portion of the population comprises students, a large urban city, a remote village, etc.), in which the point of interest is located), and/or any other factor(s) that affect a radius of influence for a commercial ecosystem of a point of interest. Based on the location of the area and/or point of interest 102 and the size of the surrounding area, the example image retriever 116 of FIG. 1 requests and receives one or more aerial images from the aerial image repository 112. The example image retriever 116 determines the scale and the relationships between the received image(s) (e.g., for use in determining distance). For example, the image retriever 116 may determine the pixel area and/or the scale from metadata associated with the image.

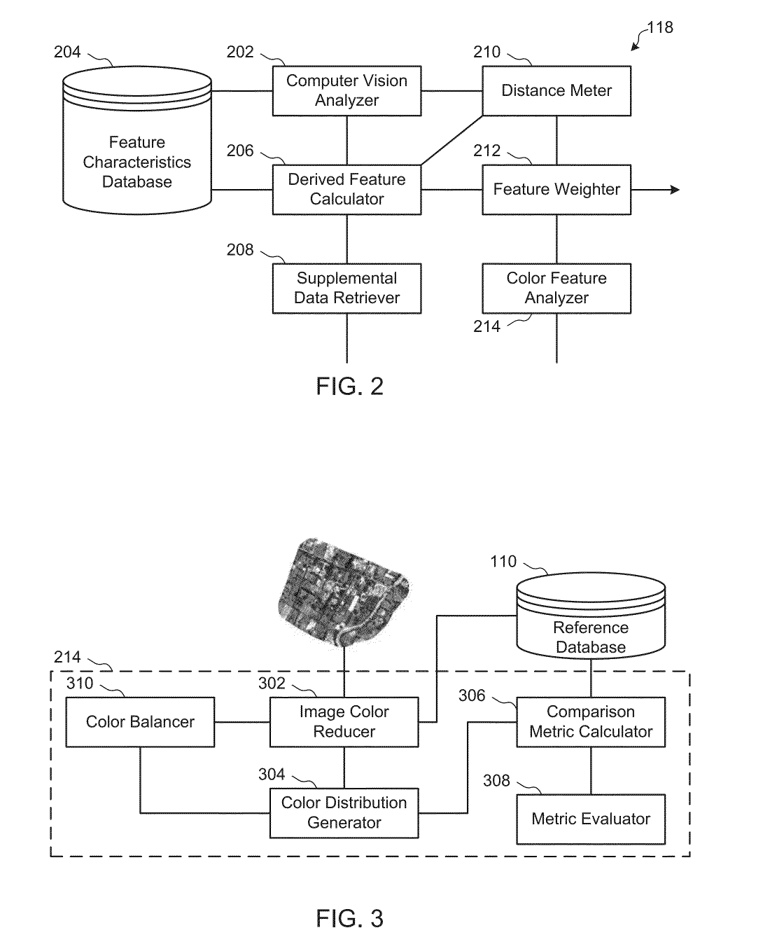

The example feature identifier 118 of FIG. 1 identifies contextual features in the aerial images obtained by the image retriever 116. FIG. 2 is a block diagram of an example implementation of the example feature identifier 118 of FIG. 1. As described in more detail below, the example feature identifier 118 uses computer vision to identify features from the images. In some examples, the feature identifier 118 supplements the visually-identified features with supplemental data obtained from other (e.g., non-image) sources.

An example implementation of the feature identifier 118 of FIG. 1 is shown in FIG. 2. The example feature identifier 118 of FIG. 2 includes a computer vision analyzer 202, a feature characteristics database 204, a derived feature calculator 206, a supplemental data retriever 208, a distance meter 210, a feature weighter 212, and a color feature analyzer 214.

The example computer vision analyzer 202 of FIG. 2 uses computer vision techniques, such as the bag-of-words model for computer vision, to identify the contextual features in the aerial images. However, the computer vision analyzer 202 may use other past, present, and/or future computer vision methods, and/or combinations of methods, to identify contextual features. The user of computer vision to identify the contextual features increases the efficiency and/or reduces the resources required to locate image(s) that are considered to match an aerial image of interest.

The example computer vision analyzer 202 of the illustrated example references characteristics of contextual features. Such characteristics are stored in the example feature characteristics database 204 of FIG. 2. For example, the characteristics of buildings in a first geographic region (e.g., city, province, country, etc.) may be different than the characteristics of the same class of building (e.g., residential single family home, shopping mall, etc.) in other geographic regions. As another example, the typical colors of roads may differ between geographic regions. When using computer vision techniques to identify contextual features in an image, the example computer vision analyzer 202 of FIG. 2 obtains key parameters associated with those contextual features (e.g., color, shape, size, texture, object density, etc.) for the geographical area represented by the aerial image.

The example feature characteristics database 204 of FIG. 2 may be populated by, for example, persons with knowledge of the characteristics of respective geographic areas and/or by persons who manually review a set of test images to determine the characteristics. In some other examples, the computer vision analyzer 202 populates and/or updates the feature characteristics database 204 through trial-and-error and/or machine learning based on feedback associated with detected contextual features.

Example contextual features that may be identified from aerial images by the computer vision analyzer 202 include buildings such as shopping malls, housing (also referred to herein as “residential buildings”), schools, high-rise buildings, commercial buildings (e.g., stores, office buildings), industrial buildings (e.g., factories), fueling stations (e.g., gasoline, diesel, electric charging, etc.), and/or transportation buildings (e.g., train stations, bus stop shelters). However, other type(s) of buildings may additionally or alternatively be identified.

The following describes example contextual features and characteristics that may be used to identify those contextual features using computer vision techniques and/or supplemental data. However, there are other contextual features that may be used. Additionally or alternatively, the characteristics may be different for some features than those discussed below (e.g., in other geographic areas).

To identify buildings such as those mentioned above, the example computer vision analyzer 202 of FIG. 2 analyzes the aerial images using computer vision techniques to identify characteristic features of the types of buildings of interest. For example, combinations of the color of a roof, the shape of the roof, the presence or lack of a roof, and/or equipment located on a roof may be used by the computer vision analyzer 202 to deduce the type of a building using the characteristics from the feature characteristics database 204. In some examples, the computer vision analyzer 202 determines a density of multiple similar buildings (e.g., at least a threshold number of buildings in a given area), a pattern of similar buildings (e.g., multiple buildings in a row facing a same direction), and/or a distance from the building(s) to a nearest road (e.g., if the buildings are close to the road or set back from the road).

The example feature identifier 118 of FIG. 2 may additionally or alternatively use the area immediately surrounding a building to determine its type (e.g., the presence of a small area surrounding the building that is a shade of the color green may indicate a residential building having a lawn or other landscaping). In some examples, the computer vision analyzer 202 identifies buildings that are under construction.

As mentioned above, the example computer vision analyzer 202 of FIG. 2 identifies roads in the example aerial images. The computer vision analyzer 202 of the illustrated example identifies roads using computer vision techniques by, for example, detecting colors associated with roads, detecting edges (e.g., lines) in the images, and/or by identifying automobiles. In some examples, the computer vision analyzer 202 identifies roads and/or confirms identifications of roads using computer vision by consulting map data from a map provider (e.g., TomTom, Garmin, etc.).

In some examples, the computer vision analyzer 202 identifies types of roads (e.g., where different types of roads may be considered different types of contextual features). Example road types may include major highways (e.g., roads having at least a threshold number of lanes, having at least a threshold amount of traffic per day and/or per working day, and/or having at least a threshold length), primary roads (e.g., roads that pass substantial amounts of traffic per day but are not major highways), local roads (e.g., side roads, roads used primarily by persons whose origin or destination location is on that road, roads that pass less than a threshold amount of traffic per day, etc.), utility roads, alleyways, bicycle paths, pedestrian walkways (e.g., sidewalks, trails, etc.), and/or any other type(s) or classification(s) of roadway. In some examples, the computer vision analyzer 202 identifies the type of road using features visible from the aerial image and/or by process of elimination (e.g., a road has a first feature common to two types of roads, but does not have a second feature that is possessed by only one of these two types of roads). The example computer vision analyzer 202 may identify major highways by identifying clover leaf-style interchanges and/or other interchanges, entrance ramps, and/or exit ramps (e.g., for entering and/or exiting the highway) between the highway and other roads. In some examples, the computer vision analyzer 202 identifies interchanges using shape detection.

In some examples, the example computer vision analyzer 202 of FIG. 2 detects patterns, arrangements, and/or densities of roads to identify particular types of buildings. For example, highly-ordered blocks of buildings and roads may indicate commercial and/or residential areas, while less-ordered and/or less-dense networks of roads may indicate non-commercial and/or non-residential areas such as industrial areas or, when combined with green space, low-density residential areas that may indicate higher wealth in some geographic areas.

In some examples, the example computer vision analyzer 202 of FIG. 2 identifies, using computer vision, counts of cars and/or car types in the aerial image(s). For example, the computer vision analyzer 202 of FIG. 2 may use polygon detection to identify types of vehicles, such as passenger cars, delivery trucks, motorcycles, and semi-trailers. In some examples, the computer vision analyzer 202 determines a type of vehicle based on the proportions of the polygons and/or the area of the polygons. For example, semi-trucks have a long length-to-width ratio relative to other vehicles, so a length-to-width ratio greater than a threshold may cause the computer vision analyzer 202 to identify a semi-truck. Because semi-trucks often use highways and/or primary roads more than local roads, the identification of semi-trucks may be a factor in identifying the type of road on which the semi-truck is photographed. In some examples, particular colors are available on certain types of vehicles such as passenger cars. Therefore, the recognition of particular colors in a road or parking area may be counted as a passenger car.

In some examples, the example computer vision analyzer 202 of FIG. 2 identifies, using computer vision, residential parking areas and/or non-residential parking areas. In some such examples, the computer vision analyzer 202 identifies parking in conjunction with and/or as a sub-function of identifying buildings. For example, the derived feature calculator 206 of FIG. 2 may presume that in-building parking is present in buildings such as high-rise buildings. The vehicle capacity may be estimated based on the size of the building.

Parking areas may be off-road parking lots (e.g., areas that have a similar color to roads but have different shapes and/or little length). Parking may additionally or alternatively be on-road parking, such as vehicles lined up on a side of a local or primary road. In some cases, on-road parking may be difficult to distinguish from a lane of vehicles traveling on the road.

In some examples, the example image retriever 116 of FIG. 1 requests and receives aerial images taken at night (“night images”) from the aerial image repository 112. The example computer vision analyzer 202 of the illustrated example uses the night images to, for example, distinguish commercial areas from residential areas. For example, in places in which most people work during the daytime and return to their homes at night (and use lights at home), the example computer vision analyzer 202 may measure, using computer vision, the light density from different locations in the image to determine where people are at night. However, in some areas the urban center containing primarily commercial buildings is brightly lit at night, which results in higher light density than in the residential areas. The light density therefore implies that people are located in the areas with the highest light density. In some examples, different color tones are identified in the night images to identify different sources of light. For example, street lights in a particular area may have a different color hue than commercial lighting, residential lighting, and/or automobile lights.

In some examples, the example computer vision analyzer 202 of FIG. 2 uses combinations of daytime images and night images to estimate commercial activity and/or daytime employment in an area represented by the images. For example, the computer vision analyzer 202 may estimate daytime employment in an area when light densities may indicate that the area is relatively inactive in the evening while daytime images indicate that there is substantial activity in the same area during the day (e.g., vehicles on roads, vehicles parked on the sides of roads and/or in parking lots, etc.). The example computer vision analyzer 202 may count vehicles, building sizes, and/or other visible features to estimate the daytime employment of the area. In some examples, the computer vision analyzer 202 may further estimate commercial activity in the area based on models relating daytime employment (alone or in combination with one or more other factors) to commercial activity.

In some examples, the example computer vision analyzer 202 of FIG. 2 identifies particular types of land uses, such as public parks and/or swimming pools, using computer vision. For example, the computer vision analyzer 202 may identify parks based on a threshold size (e.g., larger than a typical local residential lawn), colors (e.g., green and/or brown hues), and/or textures (e.g., natural textures representative of the geographic area) present in the aerial image.

In the illustrated example, the computer vision analyzer 202 of FIG. 2 identifies changes in an area based on multiple aerial images of the area taken at different times (e.g., images taken weeks, months, and/or years apart). In some such examples, the computer vision analyzer 202 identifies new types of buildings and/or counts the numbers of buildings (e.g., respective counts for different types of buildings) that have changed between images.

The example derived feature calculator 206 of FIG. 2 calculates and/or estimates contextual features based on features identified by the computer vision analyzer 202 and/or based on supplemental information available from non-image sources. The example supplemental data retriever 208 retrieves (e.g., requests and receives) supplemental data from non-image sources via, for example, the Internet and APIs provided by the sources of the supplemental information. Examples of such non-image sources that may be retrieved by the supplemental data retriever 208 and used by the derived feature calculator 206 include mapping services (e.g., mapping data), public real estate records (e.g., public real estate record data), traffic monitoring services (e.g., traffic data), and/or mobile communications service providers (e.g., mobile communications data, mobile location data, etc.).

For example, the derived feature calculator 206 may use a combination of building densities and mobile communications node activity (e.g., aggregate traffic information from one or more mobile communications nodes) to determine that an area is a daytime employment area based on a higher amount of mobile communications activity in a nearby mobile communications node during working hours than non-working hours. In some examples, the supplemental data retriever 208 accesses one or more APIs of a mapping service to determine types of establishments (e.g., retail businesses and/or other commercial activity) present in the aerial image(s). Such data may be generated by an organization and/or by crowdsourcing the information (e.g., enabling members of the public to provide and/or update information about establishments via, for example, a web site and/or the Internet).

In some examples, the derived feature calculator 206 of FIG. 2 estimates demographics of the areas associated with the aerial images. In some such examples, the derived feature calculator 206 performs the estimate using features identified by the computer vision analyzer 202 via computer vision and/or using a demography model. For example, the derived feature calculator 206 uses a demography model that is based on observable features in the aerial images. In some examples, the demography model takes as inputs combinations of automobile density, building density, building features, land uses, and/or other visible features. The example derived feature calculator 206 of FIG. 2 further obtains data or a model relating such features to demography for the geographic area. However, other observable features may additionally or alternatively be used.

In the example of FIG. 2, the derived feature calculator 206 determines a driving score (e.g., the drivability) associated with the area of interest 102. The driving score represents the accessibility of the area of interest 102 by use of motorized vehicles (e.g., cars, trucks, motorized scooters, etc.) and/or non-motorized vehicles (e.g., bicycles). The driving score may be determined based on traffic data (e.g., from a traffic information service), numbers and/or types of roads (e.g., determined by the computer vision analyzer 202, received from the traffic information service, and/or received from a mapping service), and/or the availability or quantity of motorized vehicle parking (e.g., identified by the computer vision analyzer 202) and/or non-motorized vehicle parking (e.g., bicycle racks identified by the computer vision analyzer 202).

In some examples, the derived feature calculator 206 calculates an estimated walking score (“walkability”) for the area and/or point of interest 102 and/or areas surrounding the area and/or point of interest 102. In the example of FIG. 2, the walking score of a location is a measure of the extent to which necessities, amenities, and/or luxuries are within a threshold distance (e.g., a maximum walking distance) of the location. A walking score may be considered a measure of convenience of a particular location and, thus, the desirability of a commercial (e.g., retail) location. A high walking score indicates that a high number of necessities (e.g., food, clothing, etc.), amenities (e.g., commonly-used services), and/or luxuries (e.g., non-essential goods and/or services) are available within the threshold distance. The example derived feature calculator 206 of FIG. 2 determines the walking score for an area and/or point of interest (e.g., the area and/or point of interest 102) based on weighted counts of roads of designated road types, population, income (e.g., income per capita), counts and/or square area of park(s) and/or other public space(s), pedestrian design (e.g., lengths and/or area of spaces designated or reserved for pedestrians, alone or in combination with certain classes of vehicles such as bicycles or scooters), numbers and/or types of commercial establishments, schools, and/or places of employment.

In the example of FIG. 2, the derived feature calculator 206 estimates the walking score for the locations in the aerial images and/or for the area and/or point of interest 102. In some examples, the derived feature calculator 206 calculates a walking score for one or more representative and/or arbitrary point(s) in an aerial image (e.g., four corners, center, etc.) and/or for multiple points in the aerial image. In an example of calculating a walking score, the example derived feature calculator 206 obtains respective walking distances A, B, C, and D between the area and/or point of interest 102 and a food store, a school, a park, and public transportation such as a bus stop. The food store has a weight of W, the school has a weight of X, the park has a weight of Y, and the public transportation has a weight of Z. Because the example walking score improves with reduced distances, the derived feature calculator 206 calculates the example walking score as (M−W)*A+(M−X)*B+(M−Y)*C+(M-Z)*D, where M is a selected “standard” distance.

In some examples, the derived feature calculator 206 calculates estimated residential building values (e.g., home values) from observable features (e.g., the features described above) in the aerial image(s) and/or supplemental data. For example, the derived feature calculator 206 may estimate home values in area(s) around the area and/or point of interest 102 based on building densities, nearby building types, vehicle traffic, distances to designated locations, and/or landmarks. In some examples, the derived feature calculator 206 accesses online data sources, such as online real estate sources (e.g., www.zillow.com, etc.) to estimate home values. In some examples, features observable from the image may indicate higher or lower home values. Example features that may indicate higher home values in some locations include: shorter distances to parks, bodies of water (e.g., lakes, rivers, oceans), and/or transportation features; higher elevations; desirable features on or near the property (e.g., waterfront property); the presence of swimming pools; higher concentrations of parked cars (e.g., on the sides of roads, off the roads, etc.); and/or roofs of a particular color. Additionally or alternatively, the example derived feature calculator 206 of FIG. 2 may combine the visually-observed information described above with public real estate records (e.g., sales records, taxation records) to estimate the residential building values.

In some examples, the computer vision analyzer 202 of FIG. 2 calculates an estimated urbanicity score. In the example of FIG. 2, the derived feature calculator 206 calculates the urbanicity of an area represented by the aerial image based on features identified by the computer vision analyzer 202, such as the road accessibility (e.g., how many paths there are to get to the area and/or point of interest 102), counts of total buildings, counts of commercial buildings, counts of households, daytime population (e.g., the estimated count of people present in the area of interest or around the area and/or point of interest 102 during daytime or working hours), number of ways to get to the area and/or point of interest 102 using public transit, and/or a driving score. For example, the computer vision analyzer 202 of FIG. 2 calculates the urbanicity score by multiplying a vector of urbanicity factors by a vector of urbanicity weights. The example weight vector describes the contribution of each factor toward an urbanicity score.

For example, the computer vision analyzer 202 of FIG. 2 may calculate the urbanicity score as urbanicity score=(number of paths to get to the cPOI and/or cAOI 102)*path weight+(count of total buildings in a designated area around the cPOI and/or cAOI 102)*total building weight+(count of commercial buildings in a designated area around the cPOI and/or cAOI 102)*commercial building weight+(count of households in a designated area around the cPOI and/or cAOI 102)*household weight+(daytime population in a designated area around the cPOI and/or cAOI 102)*population weight+(number of ways to get to the cPOI and/or cAOI 102 using public transit), and/or a (driving score of the cPOI and/or cAOI 102)*driving score weight.

The example distance meter 210 of FIG. 2 determines distance(s) between the cPOI and/or cAOI 102 and feature(s) identified by the computer vision analyzer 202 and/or the derived feature calculator 206. For example, the distance meter 210 of the illustrate example determines a scale of the aerial images (e.g., meters per pixel, feet per pixel, etc.) and determines the relative positions of the aerial images including the area and/or point of interest 102 and/or the identified feature. In some examples, the distance meter 210 determines the relative positions based on coordinate information associated with the aerial images (e.g., metadata of the aerial images) that designates the position(s) of one or more points in the aerial image. The example distance meter 210 calculates the distance using a number of pixels in the image(s) between the feature and the cPOI and/or cAOI 102 and the identified scale(s) of the aerial image(s). For example, if the distance meter 210 identifies a school at pixel coordinates (450, 250) in an image, the cPOI and/or cAOI 102 is located at pixel coordinates (650, 400), and the distance meter 210 determines the aerial image resolution to be 5 meters per pixel, the example distance meter 210 determines the distance to

$$be distance = \sqrt{{( 650 pixels - 450 pixels )}^{2} + {( 400 pixels - 250 pixels )}^{2}} * 1.5 meters \text{/} pixel = 375 meters .$$

In some examples, the distance meter 210 determines the ‘travel distance,’ or the distance that must be traveled using roads, walkways, and/or other physical paths, between the identified feature and the area and/or point of interest 102. Additionally or alternatively, the distance meter 210 may determine the shortest distance between the two points (e.g., the distance ‘as the crow flies,’ thereby disregarding the impact of intervening terrain such as water, mountains, and/or other man made or natural obstructions). In the example of FIG. 2, the distance meter 210 counts the number of pixels in the vertical direction and the number of pixels in the horizontal direction of an image and determines the hypotenuse using the Pythagorean theorem (c²=a²+b²) to calculate distances. The example distance meter 210 of FIG. 2 may perform the distance calculation for multiple stages (e.g., for multiple sections of a road that has bends, for a path containing multiple roads, etc.) to calculate travel distances.

The example feature weighter 212 of FIG. 2 weights features identified by the computer vision analyzer 202, the derived feature calculator 206, and/or the color feature analyzer 214. In some examples, the feature weighter 212 determines the weight for an identified feature based on the type of the feature (e.g., certain features may weigh more heavily than other features for matching aerial images and/or for characterizing the cPOI and/or cAOI) and/or based on the distance between the identified feature and the area and/or point of interest 102 calculated by the distance meter 210. For example, as the distance between a feature and the cPOI and/or cAOI 102 decreases, the example feature weighter 212 may increase the weight applied to the feature because the feature may be considered to influence the commercial ecosystem of the cPOI and/or cAOI 102 more than a same feature that is farther away from the cPOI and/or cAOI 102. In some examples, the feature weighter 212 determines the weights corresponding to a feature (e.g., a shopping mall) to be higher (or lower) when the feature is present in combination with one or more other features (e.g., a mall present in combination with a commercial building) than would be applied to that feature when the combination is not present. The example feature weighter 212 determines the weights based on the type of a feature based on empirical observation.

The example feature weighter 212 stores each weight in association with the aerial image of the feature (e.g., in the reference database 110). The weights are used by the image comparator 106 of FIG. 1 to identify which aerial images are the closest matches to the aerial images of interest.

The example color feature analyzer 214 of FIG. 2 determines a color distribution of an image including the area and/or point of interest 102 (and/or images of surrounding areas). The color distribution of an image may be used as an additional or alternative contextual feature for matching to reference images (e.g., stored in the reference database 110 of FIG. 1). An example implementation of the color feature analyzer 214 is described below with reference to FIG. 3.

The example image combiner 120 of FIG. 1 combines the features identified in multiple aerial images into a combined feature set. The example feature set includes lists of features and their associated weights. The resulting feature set may be similar or identical to a feature set generated by the feature identifier 118 for a single, larger image having the same resolution and covering the same area as the multiple aerial images. A feature set may be, for example, a vector that identifies the types of the features and identifies the weights of the features. In some examples, the vector further includes locations within the image (e.g., pixel coordinates) that enable matching of spatial relationships with other aerial images. In some examples, the feature set can be easily laid out in graphic format In the example of FIG. 1, the use of the image combiner 120 may improve the processing speed and/or reduce memory requirements by processing the images in parts (e.g., as individual aerial images) and then combining the feature sets, which are less memory-intensive.

FIG. 3 is a block diagram of an example implementation of the example color feature analyzer 214 of FIG. 2. The example color feature analyzer 214 of FIG. 3 identifies matching aerial images based on color distributions of the aerial images being sufficiently similar. In the example of FIG. 3, matching images identified by the example color feature analyzer 214 are considered to have similar commercial characteristics and may be used to impute characteristics to the area and/or point of interest 102. The example color feature analyzer 214 of FIG. 3 identifies reference images that have similar color sets and passes the identified color sets to the feature weighter 212. In some examples, the color feature analyzer 214 also provides a measure or metric of the similarities between the identified images and the aerial image to be compared, as described in more detail below. The example feature weighter 212 uses the similarity value to determine an appropriate weight for the reference images identified by the feature weighter 212. For example, a higher degree of color-based similarity (e.g., a higher similarity metric) between an aerial image and a reference image causes the feature weighter 212 to apply a higher weight to the color feature of the comparison.

The example color feature analyzer 214 of FIG. 3 includes an image color reducer 302, a color distribution generator 304, a comparison metric calculator 306, a metric evaluator 308, and a color balancer 310. In the example of FIG. 3, the resulting color distributions for the images are used as contextual features as an alternative to, or in combination with, any of the example contextual features disclosed above. In some examples, images having similar color sets are considered to be similar.

In the example of FIG. 3, reference images in the example reference database 110 are preprocessed (e.g., processed prior to characterizing a cPOI and/or cAOI) to determine and store the color distributions of the reference images. The reference database 110 stores the color distributions in association with the images from which the color distributions are generated and/or in a separate color distribution database.

The example image color reducer 302 of FIG. 3 reduces a color set of a target image (e.g., a reference image, an image including the area and/or point of interest 102, and/or an image of an area near (e.g., surrounding) the area and/or point of interest 102) to a color set in a color map. In the example of FIG. 3, colors in images are reduced to conform to a reduced color set to facilitate comparisons. An example method to reduce the color set of a target image is described below.

Prior to reducing the colors, the example image color reducer 302 of FIG. 3 scans each of the reference images in the reference database 110 to determine the colors represented by the reference images. Because of the relatively imperceptible differences between adjacent colors in, for example, the 256³-color RGB color space (e.g., the difference between (155, 155, 0) and (155, 155, 1)) and/or due to noise in the image sensors used to generate the reference images, a set of reference images can represent a large number of unique colors that would make comparing distributions of the original image colors difficult.

To make the images more comparable, the example image color reducer 302 generates a surjective color map that includes a subset of a total color set observed in the processed reference images. An example surjective map may reduce the observed set of colors in the reference images to a selected subset of the possible colors in a color set (e.g., 256 colors out of 256³ colors, 1,024 colors out of 256³ colors, etc.). For example, an aerial image may include a relatively large number of distinct colors (e.g., 15% (or some other fraction) of the 256³ possible colors in a color set (e.g., 2.5 million colors)). Each color in the surjective map represents a subset of the 256³ possible colors. For example, hundreds of shades and/or hues of “light green” may be mapped onto a specific shade and/or hue of “light green” or “green.” In other words, every color in the reference images (the observed colors) is mapped to exactly one of the 256 colors in the surjective map (the mapped colors). In some examples, the image color reducer 302 selects the mapped colors to represent similar numbers of original colors. Therefore, if there are relatively many different original RGB color values in a first general color that are very similar (e.g., lots of unique hues of “green”) and relatively few different original RGB color values in a first general color that are very similar (e.g., few unique hues of “red”), the image color reducer 302 includes proportionally more hues of green in the surjective map color set than hues of red. There is no overlap of observed colors between the mapped colors in the example of FIG. 3 (i.e., mapped colors do not share any observed colors, each observed color maps to exactly one of the mapped colors).

After creating the surjective map, the example image color reducer 302 of FIG. 3 converts each of the reference images to the color space of the mapped colors. The example image color reducer 302 also converts aerial images that are to be compared to the reference images (e.g., an aerial image including the area and/or point of interest 102) to the color space of the mapped colors. In some examples, converting the images to the color space of the mapped colors permits the image color reducer 302 to refer to the colors in the image using an index (e.g., 0-255, where each number represents one of the mapped colors) rather than an RGB value (e.g., [0-255, 0-255, 0-255]).

The example color distribution generator 304 of FIG. 3 determines the probability distributions of the colors (e.g., the color distribution) in the converted reference images. The color distribution may be a histogram of the colors that is normalized for a consistent size. The color distribution of the image is stored (e.g., in the reference database 110) as a color signature in association with the image. The color distribution generator 304 also generates the color distributions of images for comparison (e.g., an aerial image including the area and/or point of interest 102).

For each of the reference images, the example comparison metric calculator 306 of FIG. 3 calculates a comparison metric, such as a divergence, between the generated color distribution for the aerial image to be compared (e.g., an aerial image of interest) and the reference image. In the example of FIG. 3, the comparison metric calculator 306 calculates the Jensen-Shannon divergence between the distributions being compared. The square root of the Jensen-Shannon divergence provides a similarity value. The similarity value is a metric that can be compared with the similarity values for the aerial image of interest and other reference images. Comparing the similarity values enables identification of the image(s) which are most similar and/or least similar to the aerial image of interest.

The example metric evaluator 308 of FIG. 3 identifies one or more reference images that are similar to the aerial image of interest. In the illustrated example, the metric evaluator 308 compares the Jensen-Shannon similarity values calculated by the comparison metric calculator 306 to identify, for example, the X lowest similarity values and/or any similarity values traversing a designated threshold of similarity.

In some examples, the metric evaluator 308 provides the similarity values (or other comparison metric(s)) for matching reference images to the example feature weighter 212 of FIG. 2. The example feature weighter 212 of FIG. 2 uses the similarity values to calculate the weight of the color similarity in determining the most closely-matching reference images. For example, the feature weighter 212 may use a lower weight for reference images having a lower similarity and a higher weight for reference images having a higher similarity.

The example color balancer 310 of FIG. 3 balances the colors between aerial images to compensate for seasonal changes in color palettes and/or for aerial images taken using different types of sensors. For example, the colors of a location during a first time of year (e.g., spring) may be different than the colors of the same location during a different time of year (e.g., winter). Additionally, the colors of different locations may be substantially different. The example color balancer 310 may balance the colors of different surjective maps (e.g., generated by the image color reducer 302) and/or may balance the colors of different color distributions generated by the color distribution generator 304. By balancing the colors, the color balancer 310 permits comparisons of aerial images representing different locations and/or times of year.

The example color balancer 310 of FIG. 3 determines a color balancing map between corresponding colors in different seasons. For example, objects such as trees that are shades of green during the summer may be mapped to shades of brown during the winter. The example color balancer 310 determines a first time period (e.g., a first meteorological season) during which the aerial image was taken and a second time period (e.g., a second meteorological season) during which a reference image was taken. If the first and second time periods are substantially different (e.g., different seasons), the example color balancer 310 modifies the colors of one of the images (e.g., the aerial image) to correspond to the colors in the other of the images (e.g., the reference image) according to the color balancing map that maps colors associated with the first time period (e.g., summer colors) to colors associated with the second time period (e.g., winter colors). In some examples, the color balancer 310 maintains different color balancing maps for different geographic areas and/or for other distinctions. The example color balancer 310 may then select a color balancing map based on the differences in time period, geographic location, and/or other characteristics between images being compared.

Returning to FIG. 1, the example image analyzer 104 outputs the features identified by the example feature identifier 118 (e.g., as a feature set), and any associated weights applied, to the example image comparator 106. As described in more detail below, the example image comparator 106 of FIG. 1 compares the features identified by the feature identifier 118 to features stored in the reference database 110 in association with reference aerial images.

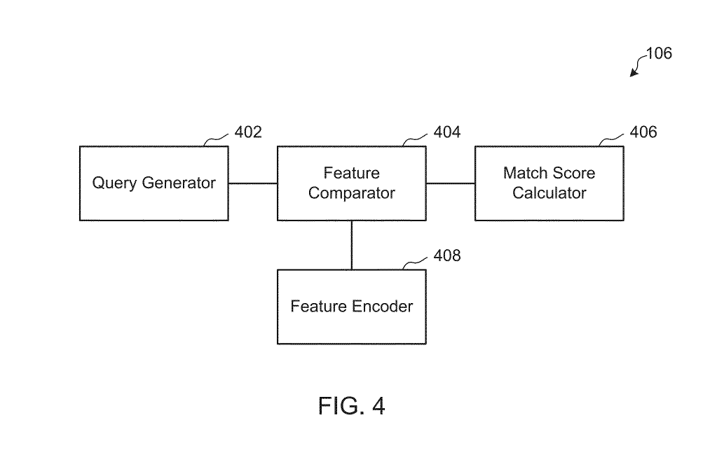

FIG. 4 illustrates an example implementation of the example image comparator 106 of FIG. 1. As mentioned above, the image comparator 106 compares an aerial image of interest to reference images to identify one or more reference images having similar contextual features. The example image comparator 106 of FIG. 4 includes a query generator 402, a feature comparator 404, a match score calculator 406, and a feature encoder 408.

The example query generator 402 of FIG. 4 queries the reference database 110 to identify reference aerial images having same or similar sets of features as the aerial image(s) of interest. For example, the query generator 402 may query the reference database 110 using the most highly-weighted features present in the aerial image(s) of interest first. The results of the first query may then be queried on one or more lower-weighted features to narrow the list of results until a desired list of results is obtained (e.g., top ten results, some other number of similar results, etc.).

In some other examples, the query generator 402 does not use weights to identify the closest-matching reference aerial images. Instead, in some such examples, the query generator 402 queries the reference database 110 to identify reference aerial images having a highest number of matching features and/or similar distances between matching features and a designated point. In some such examples, the example feature comparator 404 and/or the match score calculator 406 use the weights of matching features to resolve any ties between reference aerial images to determine the closest-matching images.

In the example of FIG. 4, the query generator 402 initially searches for the presence of features in the reference aerial images. When one or more reference aerial images are identified, the example feature comparator 404 compares the features of the aerial images of interest with the features of the reference aerial image(s) to determine numbers and/or weights of features that match between an aerial image of interest and a reference aerial image. In some examples, when comparing an aerial image of interest with a reference aerial image, the feature comparator 404 identifies the features that are present in both images (e.g., matching features). In some examples, multiple similar or identical features may be present in an aerial image of interest (e.g., multiple parking areas, multiple residential areas, etc.). In some such examples, the feature comparator 404 identifies the number of matching features as the lower number of those features in the aerial image of interest or the reference aerial image. For example, if the aerial image of interest has three identified public parks and the reference aerial image has two identified public parks, the example feature comparator 404 determines there to be two matching public park features.

Some contextual features are based on an image or portion of an image rather than having a specific location within the image. For example, an urbanicity, a walkability score, daytime employment, commercial activity, and/or home values may be features for an area within the aerial image and/or the aerial image as a whole. The example feature comparator 404 of FIG. 4 compares such contextual features by, for example, determining whether the same type(s) of contextual features (e.g., urbanicity scores, walking scores, etc.) are within a threshold range of one another. For example, the feature comparator 404 may determine whether a walking score of a reference image is within +/−0.5 of the walking score of the aerial image of interest (e.g., on an index scale of 0 to 10.0). As another example, the feature comparator 404 determines whether an estimated daytime population of a reference aerial image is within a threshold number of people (e.g., +/−100 people, +/−500 people, +/−1,000 people, +/−2,000 people, etc.) and/or a threshold percentage of people (e.g., +/−5%, +/−20%, etc.) of the estimated daytime population of the aerial image of interest. However, the feature comparator 404 may make other comparisons based on empirically-determined ranges of scores or metrics. Any of these contextual features may have any type of threshold (e.g., index, percentage, number, etc.). If the feature comparator 404 determines that the contextual feature values for the reference aerial image and the aerial image of interest match, the example feature comparator 404 of the illustrated example treats the feature as being present in both images.

The example match score calculator 406 of FIG. 4 determines a match score between each aerial image of interest and each reference image resulting from the query of the reference database 110. In some examples, the example match score calculator 406 sums the weights of the features (e.g., the weights of the feature from one of the compared feature sets, an average of the weights for the feature in the features sets, a multiplication of the weights for the feature in the features sets, etc.) identified by the feature comparator 404 to determine a total matching score. Thus, the closest-matching reference image to an aerial image of interest may be a reference image having highly-weighted features or a reference image sharing a high number of same features with the aerial image of interest.

For example, if an aerial image has a feature set of (feature E, weight 10; feature F, weight 12; feature G, weight 15; feature H, weight 50) and a reference image has a feature set of (feature E, weight 16; feature G, weight 44; feature J, weight 88), the example feature comparator 404 determines that the aerial image and the reference image share features E and G. Using the average of the weights of matching features, the example match score calculator 406 determines the match value to be match score=(10+16)/2+(15+44)/2=42.5. The example image comparator 106 may then compare the match score to other match scores and/or to a threshold.

In some examples, the match score calculator 406 triangulates a position in a reference aerial image using the shared features present in both the aerial image of interest and the reference aerial image (e.g., identified by the feature comparator 404). For example, the match score calculator 406 may use the distances determined by the distance meter 210 of FIG. 2 for the features shared by the images.

The reference aerial image is unlikely to have a point at which the set of shared features are the same respective distances from the features to the point as the distances from the shared features and the area and/or point of interest 102 in the aerial image of interest, especially for large numbers of features (e.g., because the number of permutations of features and distances in unplanned areas is very high). Because such a point is unlikely to be present in the reference aerial image, the example match score calculator 406 may use a method such as regression analysis to identify a closest-matching point in the reference aerial image. For example, the closest-matching point may be the point in the reference aerial image that has the lowest total difference between the distances from the shared features to the point, relative to the distances between the shared features and the area and/or point of interest 102 in the aerial image of interest. The example match score calculator 406 outputs the identified point (e.g., coordinates of the identified point), and/or the entire reference aerial image, to the example point/area of interest classifier 108 for classification of the area and/or point of interest 102.

The example point/area of interest classifier 108 of FIG. 1 receives the identification of the matching reference aerial image(s) from the image comparator 106 and/or points in the identified matching reference aerial image(s). Based on the matching reference aerial image(s), the example point/area of interest classifier 108 of the illustrated example classifies the area and/or point of interest 102. Example classifications may reflect the quantity and/or characteristics of retail clientele likely to be present or to frequent the area and/or point of interest 102. Additionally or alternatively, the classifications may reflect the anticipated demand for class(es) and/or type(s) of goods and/or services.

To classify the reference image, the example point/area of interest classifier 108 retrieves the commercial characteristics (as opposed to the contextual features) of the identified reference aerial image(s) from the reference database 110. As mentioned above, each of the reference aerial image(s) in the reference database 110 have known characteristics determined from performing counting, sampling, and/or other procedures to determine the “ground truth.” As used herein, “ground truth” refers to information collected at the location and intended to accurately depict the characteristics of the area. The ground truthing may be performed by, for example, a market survey and/or research service. The ground truth results are stored in association with the reference aerial image of the characterized area.

In some examples, the point/area of interest classifier 108 assumes the characteristics of the area and/or point of interest 102 to be the same as the characteristics of the most closely-matching reference aerial image. For example, the point/area of interest classifier 108 may use the characteristics of the most closely-matching reference aerial image when the number of matching features and/or total matching weight are sufficiently high (e.g., traverse a “highly matching” threshold, which may be determined empirically). In some such examples, the point/area of interest classifier 108 excludes one or more of the characteristics of the reference aerial image from being applied to the area and/or point of interest 102 when, for example, other less-closely matching reference aerial images indicate that the excluded characteristic(s) are not representative of the area and/or point of interest 102.

In some examples, the point/area of interest classifier 108 determines the characteristics of the area and/or point of interest 102 based on characteristics of two or more reference aerial images. For example, the point/area of interest classifier 108 may identify a set of characteristics shared by all and/or a subset of two or more reference aerial images identified by the image comparator 106. If at least a threshold number of the reference aerial images is associated with the characteristic, the example point/area of interest classifier 108 classifies the area and/or point of interest 102 as having the characteristic.

In some examples, the point/area of interest classifier 108 determines the characteristics of the area and/or point of interest 102 by determining the characteristics of a particular point in a reference aerial image for which ground truth has been determined. As mentioned above, the example image comparator 106 may identify one or more points in a reference aerial image that match the point of interest based on matching features. If ground truth is associated with the identified point in the reference aerial image (e.g., when different points in the image have been determined to have different characteristics), the example point/area of interest classifier 108 associates the characteristics of the identified point with the area and/or point of interest 102.

The example reference database 110 of FIG. 1 stores the data and/or metadata representing the features associated with the reference aerial images. In some examples, the features for reference aerial images are only associated with the reference aerial images from which they were identified. In some other examples, the image combiner 120 combines the reference aerial images to generate reference feature sets. In the example of FIG. 1, the reference database 110 stores locations (e.g., coordinates) of the features present in the reference aerial images.

Because the example image comparator 106 of the example of FIG. 1 does not search the image data of the reference aerial images directly, in some examples the reference database 110 does not store the reference aerial images and instead only stores the data and/or metadata representing the features and/or describing the reference aerial images. In some other examples, the reference database 110 stores the aerial images and/or stores links to the reference aerial images stored in a separate database.

The example feature encoder 408 of FIG. 4 applies a designated color for a particular type of contextual feature to the location in the aerial image of the selected feature. For example, if a parking lot feature is associated with a designated shade of red, the example feature encoder 408 includes a feature of the designated shade (e.g., a pixel, a shape including multiple pixels, etc.) at the location of the parking lot (e.g., at the center of the parking lot, at the point in the parking lot closest to the point of interest, etc.). If a type of contextual feature is associated with an area (e.g., a residential area, a commercial area, etc.), the example feature encoder 408 may encode the designated color at a deterministically-selected location in the area associated with the feature.

If the selected feature is a numerical characteristic of the area and/or point of interest 102 and/or an area surrounding and/or near the area and/or point of interest 102, the feature encoder 408 may, for example, encode a color on or near the area and/or point of interest 102 that is associated with the selected type of feature and/or a range of the numerical value determined for the feature. For example, a daytime population of 10,000-50,000 may be associated with a designated shade of yellow, in which case the feature encoder 408 encodes one or more pixels in the aerial image with the shade of yellow when the daytime population feature is determined to fall within the 10,000-50,000 range.

Where desired, the example feature encoder 408 encodes each type of feature onto the aerial image. The example color feature analyzer 214 of FIG. 2 may then determine color distributions using only the assigned contextual feature colors (e.g., without converting features to the surjective color map). Thus, the example image comparator 106 may compare the color distributions to determine the most closely matching reference aerial images based on the color distributions of the contextual feature colors.

While example manners of implementing the image analyzer 104, the image comparator 106, and the point/area of interest classifier 108 of FIG. 1 are illustrated in FIGS. 2, 3, and/or 4, one or more of the elements, processes and/or devices illustrated in FIGS. 2, 3, and/or 4 may be combined, divided, re-arranged, omitted, eliminated and/or implemented in any other way. Further, the example image analyzer 104, the example image comparator 106, the example point/area of interest classifier 108, the example reference database 110, the example image retriever 116, the example feature identifier 118, the example image combiner 120, the example computer vision analyzer 202, the example feature characteristics database 204, the example derived feature calculator 206, the example supplemental data retriever 208, the example distance meter 210, the example feature weighter 212, the example color feature analyzer 214, the example image color reducer 302, the example color distribution generator 304, the example comparison metric calculator 306, the example metric evaluator 308, the example color balancer 310, the example query generator 402, the example feature comparator 404, the example match score calculator 406, the example feature encoder 408, and/or, more generally, the example system 100 of FIG. 1 may be implemented by hardware, software, firmware and/or any combination of hardware, software and/or firmware. Thus, for example, any of the example image analyzer 104, the example image comparator 106, the example point/area of interest classifier 108, the example reference database 110, the example image retriever 116, the example feature identifier 118, the example image combiner 120, the example computer vision analyzer 202, the example feature characteristics database 204, the example derived feature calculator 206, the example supplemental data retriever 208, the example distance meter 210, the example feature weighter 212, the example color feature analyzer 214, the example image color reducer 302, the example color distribution generator 304, the example comparison metric calculator 306, the example metric evaluator 308, the example color balancer 310, the example query generator 402, the example feature comparator 404, the example match score calculator 406, the example feature encoder 408 and/or, more generally, the example system 100 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example image analyzer 104, the example image comparator 106, the example point/area of interest classifier 108, the example reference database 110, the example image retriever 116, the example feature identifier 118, the example image combiner 120, the example computer vision analyzer 202, the example feature characteristics database 204, the example derived feature calculator 206, the example supplemental data retriever 208, the example distance meter 210, the example feature weighter 212, the example color feature analyzer 214, the example image color reducer 302, the example color distribution generator 304, the example comparison metric calculator 306, the example metric evaluator 308, the example color balancer 310, the example query generator 402, the example feature comparator 404, the example match score calculator 406, and/or the example feature encoder 408 is/are hereby expressly defined to include a tangible computer readable storage device or storage disk such as a memory, a digital versatile disk (DVD), a compact disk (CD), a Blu-ray disk, etc. storing the software and/or firmware. Further still, the example system 100 of FIG. 1 may include one or more elements, processes and/or devices in addition to, or instead of, those illustrated in FIGS. 1, 2, 3, and/or 4, and/or may include more than one of any or all of the illustrated elements, processes and devices.

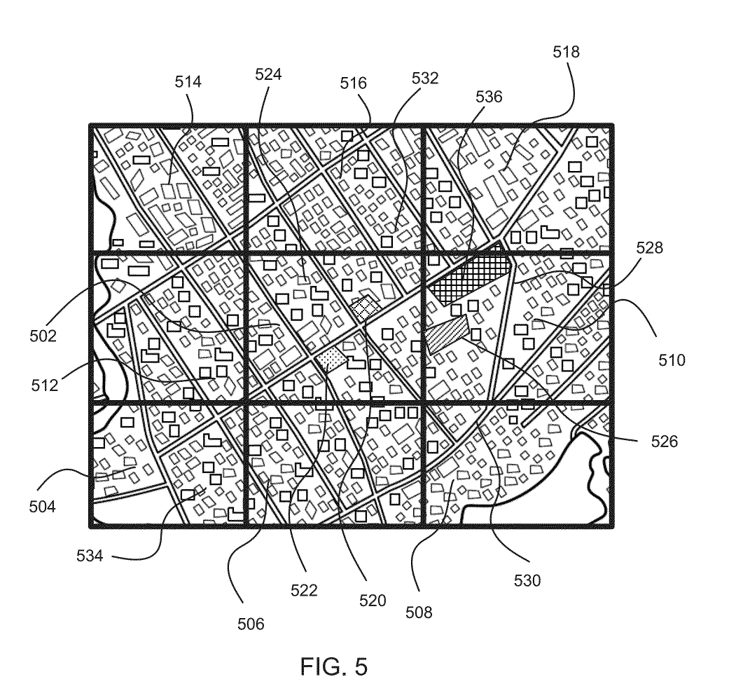

FIG. 5 illustrates an example collection of aerial images 502-518 including a first example commercial point/area of interest 520 and areas surrounding the first example commercial point/area of interest 520, from which examples disclosed herein may determine contextual features to determine a commercial ecosystem of the first commercial point/area of interest 520.

The example image retriever 116 of FIG. 1 retrieves the aerial images 502-518 (e.g., from the aerial image repository 112 of FIG. 1) based on an identification of the first commercial point/area of interest 520 (e.g., based on an input identifying a cPOI and/or a cAOI) to the image retriever 116). For example, the image retriever 116 requests the aerial image including the point/area of interest 520. Based on the returned image 502, the image retriever 116 determines and requests the aerial images 504-518 adjacent to the image 502. The example aerial images 502-518 of FIG. 5 are non-overlapping images, but in some other examples are partially overlapping.

The example computer vision analyzer 202 of FIG. 2 analyzes the example aerial images 502-518 to identify contextual features using computer vision techniques. In the example of FIG. 5, the computer vision analyzer 202 identifies vehicles in the aerial image(s) 502-518 based on, for example, identifying shapes and/or proximity to roads. The example computer vision analyzer 202 further identifies an area as a parking space 522 based on one or more of a color of the space 522, the presence of identified vehicles in the space 522, an arrangement of the vehicles in the parking space 522 (e.g., multiple vehicles lined up in a row, with or without multiple rows), and/or the space 522 not being identified as a road.

In the example aerial image 502, the example computer vision analyzer 202 also identifies a block of buildings 524 as including commercial buildings (e.g., office buildings, etc.), or primarily commercial buildings (e.g., buildings including commercial and non-commercial units), using computer vision. The computer vision analyzer 202 may identify the buildings 524 as commercial buildings based on shape(s) of the buildings 524, the density of the buildings 524, and/or the colors of the rooftops of the buildings 524. In some examples, the computer vision analyzer 202 may provide information about the buildings to the derived feature calculator 206. The derived feature calculator 206 may then use additional information (e.g., third party mapping information, traffic information, cell phone usage data, etc.) obtained via the supplemental data retriever 208 to identify the buildings 524 as commercial buildings.

In addition to processing features in the image 502, the example computer vision analyzer 202 of FIG. 2 processes the aerial images 504-518. For example, the computer vision analyzer 202 of FIG. 2 analyzes the example aerial image 510 to identify green space 526 such as a public park. In the example of FIG. 5, the computer vision analyzer 202 identifies the green space 526 using computer vision techniques by identifying the area as having at least a threshold area with pixel colors falling within a range of green hues. Additionally or alternatively, the example computer vision analyzer 202 identifies the green space 526 by determining that the example green space 526 has a particular texture (or one of multiple textures) associated with parks or green space.

The example computer vision analyzer 202 of FIG. 2 further identifies roads in the aerial images 502-518 such as a local road 528 (e.g., a lower traffic and/or lower speed roadway) and a highway 530 (e.g., a higher traffic and/or higher speed roadway). In the example of FIG. 5, the computer vision analyzer 202 identifies the local road 528 and/or the highway 530 using computer vision techniques and based on respective widths of the roadways 528, 530, average numbers of cars identified on respective lengths of the roadways 528, 530, and/or the respective colors of the roadways 528, 530.

The example computer vision analyzer 202 of FIG. 2 identifies a residential area 532 in the example aerial image 510 and/or identifies an industrial area in the example aerial image 504 of FIG. 5. To identify the residential area 532 and/or the industrial area 534, the example computer vision analyzer 202 and/or the derived feature calculator 206 of FIG. 2 may use the same computer vision techniques and information used to identify the commercial area 524. However, the example computer vision analyzer 202 and/or the derived feature calculator 206 access the feature characteristics database 204 to determine whether different shapes, colors, and/or densities apply to buildings in residential and/or industrial areas.

While example features are described with reference to FIG. 5, the example computer vision analyzer 202 and/or the derived feature calculator 206 may identify other type(s) of feature(s) from the aerial images 502-518. In some examples, the computer vision analyzer 202 and/or the derived feature calculator 206 perform scans for particular types of feature(s) in response to identifying certain feature(s). For example, identifying one type of contextual feature may lead to analyzing the aerial images of interest for a second type of contextual feature, for which the computer vision analyzer 202 may not otherwise search. Thus, the example computer vision analyzer 202 and/or the derived feature calculator 206 attempt to identify combinations that are representative of contextual features.

The example derived feature calculator 206 of FIG. 2 derives additional contextual features associated with the aerial images 502-518 using the features identified by the computer vision analyzer 202 and/or supplemental information obtained by the supplemental data retriever 208. For example, the derived feature calculator 206 determines an urbanicity, a walkability score, daytime employment and/or commercial activity, and/or home values for the area represented by the aerial images 502-518.

The example derived feature calculator 206 calculates an urbanicity of the point/area of interest 520 based on, for example, the road accessibility (e.g., the quantity and type(s) of the roads 528, 530 in the aerial images 502-518), count(s) of buildings (e.g., total buildings, commercial buildings, and/or households), daytime population (e.g., the estimated count of people present in the area or around the point/area of interest 520 during daytime or working hours), a number of ways to get to the area and/or point of interest 102 using public transit, and/or a driving score.

When the computer vision analyzer 202 and/or the derived feature calculator 206 have identified the contextual features present in the images 502-518, the example distance meter 210 of FIG. 2 determines the distances (e.g., in meters) between the identified features and the point/area of interest 520. In the example of FIG. 5, the distance meter 210 identifies a shortest distance (e.g., from a closest point of the identified feature to the closest point of the point/area of interest 520). In some other examples, the distance meter 210 uses an average distance, such as a distance between centers of the feature and the point/area of interest 520.

To determine the distance between features in the images 504-518 other than the image 502 including the point/area of interest 520, the example distance meter 210 aligns the images 502-518 using overlapping sections and/or using coordinate and scale information in the metadata of the images 502-518. When the distance meter 210 has aligned the images, the example distance meter 210 determines a number of pixels in the vertical and horizontal directions and calculates the distance to be the hypotenuse of the vertical and horizontal pixel distances. The example distance meter 210 then converts the distance from pixels to meters (or other unit of measurement such as yards or miles). In some other examples, the distance meter 210 determines the distance from an identified feature (e.g., the parking space 522, the highway 530, etc.) to the point/area of interest 520 using road distances. Using road distances, the example distance meter 210 may be required to perform multiple calculations of distance for different roads and/or different segments of the same road that travel in different directions along the route.

The example color feature analyzer 214 of FIGS. 2 and/or 3 identifies respective color distributions of the example images 502-518. In the example of FIG. 5, the color feature analyzer 214 reduces the color set(s) of the images 502-518 to a designated color set prior to calculating the distributions. The example color feature analyzer 214 outputs the color distributions as contextual features.

The example feature weighter 212 weights the features identified by the computer vision analyzer 202, the derived feature calculator 206, and/or the color feature analyzer 214. The feature weighter 212 outputs the features and their respective weights to the image comparator 106 of FIG. 1 for comparing to reference aerial images in the reference database 110. In the example of FIG. 5, the feature weighter 212 weights the presence of the commercial buildings 524, the parking area 522, and the large commercial building 536 highly due to their proximity to the point/area of interest 520 and/or based on an empirically-determined influence of these features on the commercial characteristics of a location. However, this is only an example, and weight functions applied by the example feature weighter 212 may differ based on different empirical data regarding relationships between features and nearby commercial ecosystems, observable features, geographic region, and/or access to supplemental data, among other things.

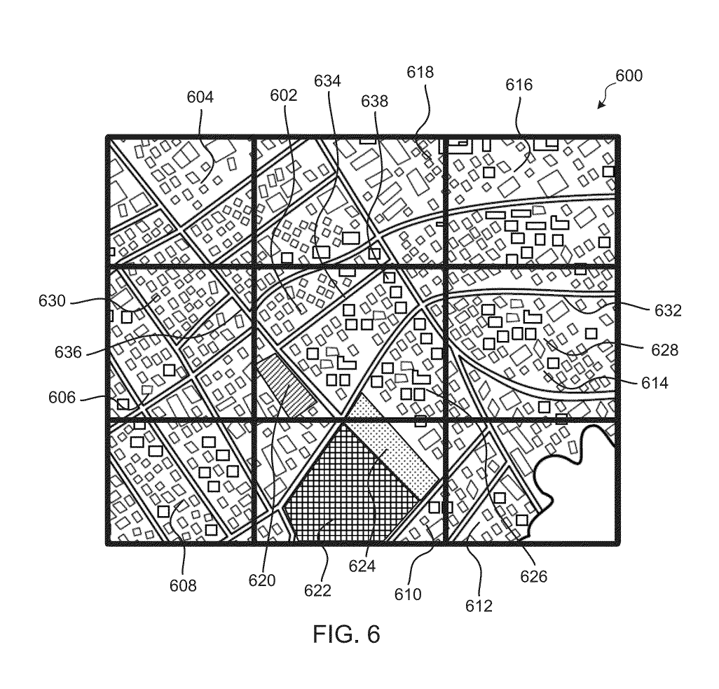

FIG. 6 illustrates an example closest-matching reference image 600 to the aerial image 502 of FIG. 5 in a reference database as determined by the example system 100 of FIG. 1. In the example of FIG. 6, the closest-matching reference image 600 is an aggregation of multiple images 602-618 of smaller areas than the image 600. The example image 600 is centered on one of the smaller images 602 that is determined to most closely represent the point/area of interest 520 of FIG. 5 based on contextual features present in the image 602 and/or the surrounding images 604-618.

To identify the reference image 600 as a closest match, the example image analyzer 104 of FIGS. 1 and/or 2 identifies contextual features in the example images 602-618. The contextual features are identified in the image 602-618 prior to classifying the point/area of interest 520 and may be identified by the same techniques described herein to identify contextual features for the point/area of interest 520 and/or as part of manually determining the ground truth and/or commercial characteristics of the area depicted by the image(s) 602-618. The features identified in the images 602-618 are stored in association with those images in the example reference database 110 of FIG. 1.

Example contextual features present in the example images 602-618 include a public park 620, a large retail center 622 (e.g., a shopping mall), a vehicle parking area 624, commercial areas 626, 628, a residential area 630, a highway 632, and local roads 634, 636, a fueling station 638, an urbanicity, a walking score, a daytime population, and one or more color distributions.

The example image comparator 106 of FIG. 1 identifies the image(s) 602-618 of FIG. 1 by performing queries using the features and/or weights (e.g., vectors including the features and/or weights assigned to the features) associated with the images 502-518 of FIG. 5. For example, the image comparator 106 generates a query and/or one or more subqueries as a vector that includes the highest-weighted features identified in the images 502-518. For example, the image comparator 106 may generate a query vector to include a number of features (e.g., 5 features, 10 features, 15 features, any other number, or all of the features) that have the highest weights of all of the identified features of the images 502-518 (e.g., the features in the vectors representative of the feature sets of the images 502-518). In some examples, a subset of the images 602-618 of FIG. 6 that contain the features 620-638 (e.g., the images 602, 606, 610, and 614) are identified by the image comparator 106, and the remaining images in the reference aerial image 600 (e.g., 604, 608, 612, 616, and 618) are selected by association with the subset to form the full reference aerial image 600.

After the image comparator 106 identifies the image(s) 602-618 of FIG. 6 as being most closely matched of the reference aerial images in the reference database 110, the example point/area of interest classifier 108 of FIG. 1 identifies the commercial characteristics associated with the images 602-618 from the reference database 110. For example, the point/area of interest classifier 108 may determine that the images 602-618, or a subset of the images 602-618, have commercial characteristics associated with primarily commercial retail demands, such as higher levels of demand for restaurants and convenience stores and lower levels of demand for grocery stores and/or clothing stores. However, other commercial characteristics, and/or combinations of commercial characteristics and/or classifications, may be used to describe the commercial ecosystem in one or more of the images 602-618. The example point/area of interest classifier 108 classifies commercial ecosystem for the point/area of interest 520 based on the commercial characteristics of the images 602-618. In the example of FIGS. 5 and 6, the point/area of interest classifier 108 classifies the point/area of interest 520 as existing in a commercial ecosystem associated primarily with commercial retail demands.

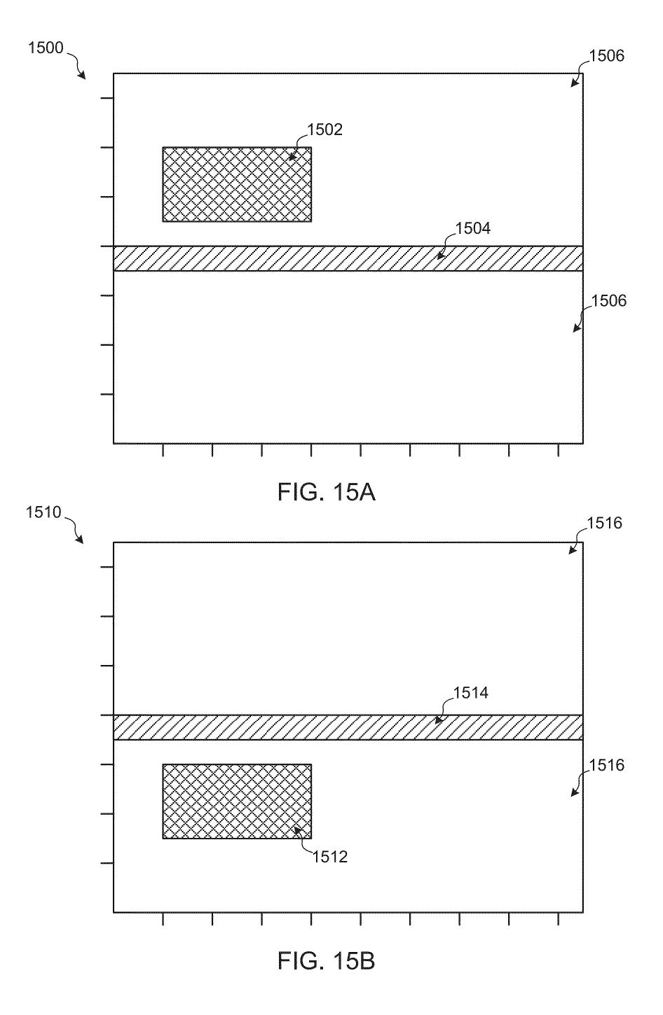

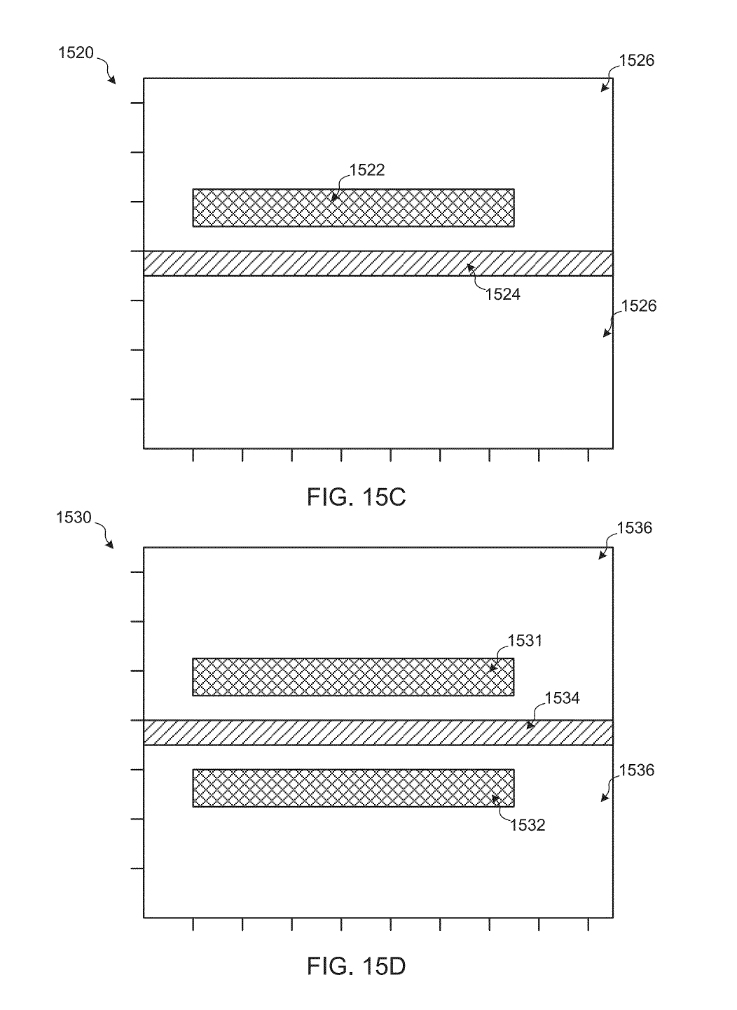

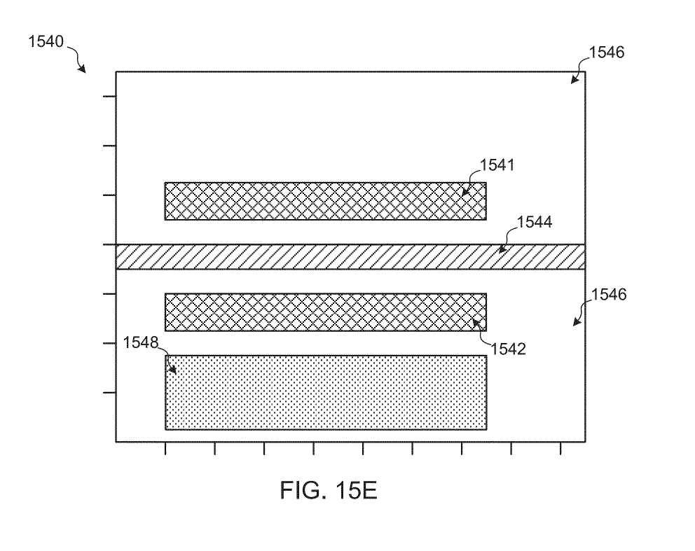

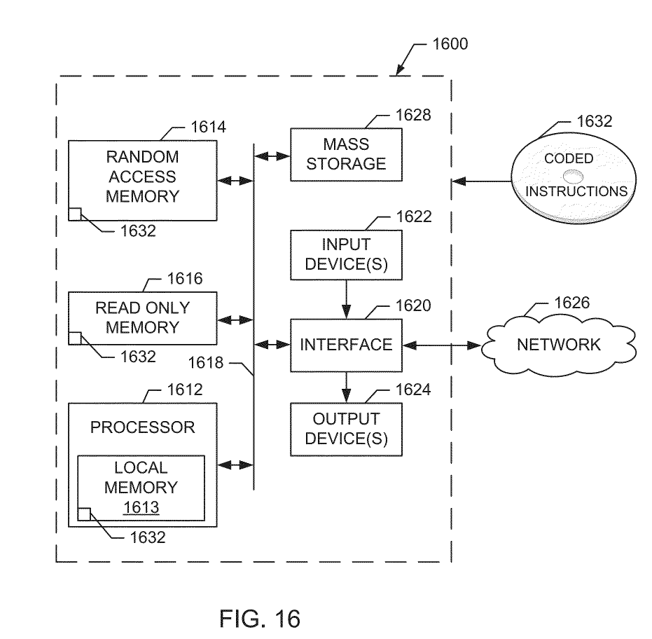

FIGS. 15A-15E illustrate example images 1500, 1510, 1520, 1530, 1540 of geographic areas 1502, 1512, 1522, 1532, 1542 that have been color-coded according to features present in the images 1500, 1510, 1520, 1530, 1540. An example of color-coding and matching aerial images is described below using the example images 1500, 1510, 1520, 1530, 1540.

The example image 1500 of FIG. 15A represents a reference geographic area that includes a commercial building 1502, a road 1504, and undeveloped area 1506 (e.g., grass-covered land, dirt-covered land, etc.). The example computer vision analyzer 202 of FIG. 2 identifies each of the example features 1502-1506 of FIG. 15 by analyzing an aerial image of the geographic area represented in FIG. 15A using feature characteristics from the feature characteristics database 204 as described above. The aerial image may be obtained from the aerial image repository 112 of FIG. 1.

Each of the types of identified features 1502-1506 in the example image 1500 is associated with a unique color (e.g., a unique RGB value). The association between features and colors may also be stored in the feature characteristics database 204 as an image feature. The example image color reducer 302 of FIG. 3 converts the identified features 1502-1506 in the image 1500 to the unique colors assigned to the respective identified features 1502-1506. For example, the pixels representing the commercial building 1502 in the image 1500 are converted to a first color (e.g., yellow) that is stored as the color for commercial buildings in the feature characteristics database 204. The result of the conversion of the feature 1502 is a block of a uniformly-colored pixels in the location in which the aerial view of the commercial building 1502 was shown prior to the conversion.

Similarly, the example derived feature calculator 206 converts the road 1504 to a block of a second uniform color (e.g., black) and converts the undeveloped area(s) 1506 in the image 1500 into a third uniform color (e.g., green). The example undeveloped area 1506 of FIG. 15A is divided into multiple sections by the road 1504.

The example distance meter 210 of FIG. 2 also determines the spatial relationships present in the image 1500. For example, the distance meter 210 determines the distances and/or dimensions of the features 1502-1506 in the image (e.g., the dimensions of the features 1502-1506) by multiplying the scale or resolution of the image 1500 (e.g., X meters per pixel) by the number of pixels in a row or column of pixels, and/or using the Pythagorean theorem, as needed, to obtain distances. The example distance meter 210 determines, for example, the dimensions of the commercial building 1502 (e.g., the length and width dimensions), the dimensions of the road 1504 within the bounds of the image 1500, and/or the dimensions of the undeveloped area(s) 1506.

Additionally or alternatively, the example distance meter 210 determines distance(s) between features 1502-1506, such as the distance between the commercial building 1502 and the road 1504. Features such as distances and/or dimensions provide spatial information that may be useful for matching images. In some examples, the computer vision analyzer 202 determines directional bearings (e.g., North, South, East, West, and/or intermediate bearings) between pairs of the features 1502-1506. For example, the computer vision analyzer 202 may determine that the commercial building 1502 is north of the road 1504 or, conversely, that the road 1504 is south of the commercial building 1502. The colors, dimensions, distances, and/or directions are stored as characteristics of the features 1502-1506.

In the example of FIG. 15A, ground truth analysis has been conducted. The results of the ground truth analysis indicate that the commercial building 1502 includes 3 stores: a pharmacy, a beauty salon, and an electronics store. The example colors, dimensions, distances, bearings, and/or ground truth results are stored in a reference database 110 with the image 1500 (e.g., for later comparison and/or classification of other images of areas of interest).

FIG. 15B illustrates another example image 1510 that represents a geographic area of interest. The example image 1510 has been converted (e.g., via the computer vision analyzer 202 and the derived feature calculator 206) to colors corresponding to features detected in the image 1510. The example image 1510 of FIG. 15B includes a commercial building 1512, a road 1514, and an undeveloped area 1516. The example distance meter 210 of FIG. 2 determines dimensions and/or distances associated with the image 1510, such as the commercial building 1512 and the road 1514. The example image comparator 106 compares the images 1500 and 1510 by comparing color histograms of the images 1500 and 1510, dimensions of the features 1502-1506 and 1512-1516, distances between ones of the features 1502-1506 and 1512-1516, and/or directions from ones of the features 1502-1506 and 1512-1516 to other ones of the features 1502-1506 and 1512-1516. The example image comparator 106 may determine that the image 1510 has a high score for matching (e.g., a score indicating a match) with the image 1500 due to having similar features (e.g., from substantially identical color histograms), similar dimensions for the features 1502 and 1512, and/or similar distances between the features 1502 to 1504 and the features 1512-1514.

FIG. 15C illustrates another example image 1520 that represents a reference geographic area that includes a commercial building 1522, a road 1524, and undeveloped area 1526. Notably, the example commercial building 1522 has different dimensions than the example commercial building 1512 in the image 1510 of FIG. 15B. When comparing the images 1510 and 1520 using the respective colors, the distances, the dimensions, and/or the directions, the example images 1510, 1520 have the same color histogram (e.g., due to the buildings 1512, 1522 having the same surface area). However, the different dimensions between the buildings 1512, 1522 reduces the matching score calculated by the color feature analyzer 214. As a result, the color feature analyzer 214 may calculate a lower matching score for the comparison of the image 1510 and the image 1520 than for the comparison of the image 1510 and the image 1500.

FIG. 15D illustrates another example image 1530 that represents a reference geographic area that includes two commercial buildings 1531, 1532, a road 1534, and undeveloped area 1536. The example image 1530 differs from the example image 1510 to be matched in that the images 1510, 1530 have different color histograms due to the difference in the number of commercial buildings 1512, 1531, 1532 and/or in the amounts of undeveloped area 1516, 1536. The image 1530 also differs from the example image 1510 in that the commercial buildings 1531, 1532 both have different dimensions than the example commercial building 1512. As a result, the color feature analyzer 214 may calculate a lower matching score for the comparison of the image 1510 and the image 1530 than for the comparison of the image 1510 and the image 1500.

FIG. 15E illustrates another example image 1540 that includes two commercial buildings 1541, 1542, a road 1544, undeveloped area 1546, and residential area 1548. When determining a matching score for the comparison of the image 1540 and the image 1510 of FIG. 15B, the example color feature analyzer 214 would identify a difference between the color histograms for the image 1510 and the image 1540 due to the higher area of commercial buildings and the presence of the commercial area in the image 1540 that is not present in the image 1510. Thus, the example color feature analyzer 214 may determine that the matching score for the color feature analyzer 214 may calculate a lower matching score for the image 1510 and the image 1540 than for the image 1510 and the image 1500, for the image 1510 and the image 1520, and/or for the image 1510 and the image 1530.

After comparing the example image 1510 to the images 1500, 1520, 1530, 1540, the example color feature analyzer 214 determines that the image 1500 is a closest match to the image 1510. Based on identifying the image 1500 as the closest match to the image 1510 and based on the ground truth associated with the image 1500, the example point/area of interest classifier 108 of FIG. 1 estimates that the commercial building 1512 of FIG. 15B (e.g., the cAOI and/or the cPOI) represents a pharmacy, a beauty salon, and an electronics store. The example point/area of interest classifier 108 may additional make predictions about future development to the geographic area represented in FIG. 15B based on changes to the area represented in FIG. 15A over time (e.g., additional developments or features added to the area, changes in store composition, etc.).

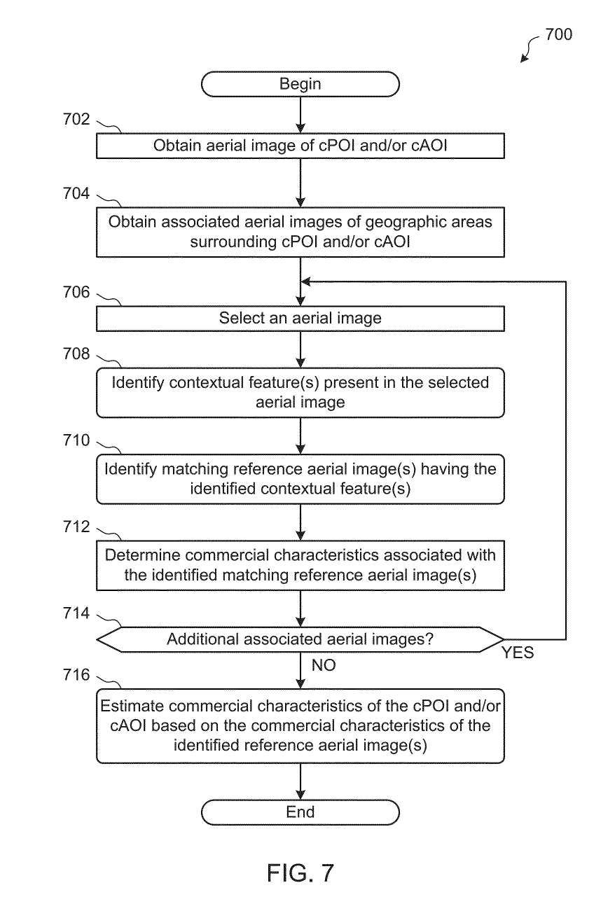

Flowcharts representative of example machine readable instructions for implementing the system 100 of FIG. 1 are shown in FIGS. 7, 8A-8B, 9, 10, 11, 12, 13, and 14. In this example, the machine readable instructions comprise programs for execution by a processor such as the processor 1612 shown in the example processor platform 1600 discussed below in connection with FIG. 16. The programs may be embodied in software stored on a tangible computer readable storage medium such as a CD-ROM, a floppy disk, a hard drive, a digital versatile disk (DVD), a Blu-ray disk, or a memory associated with the processor 1612, but the entire programs and/or parts thereof could alternatively be executed by a device other than the processor 1612 and/or embodied in firmware or dedicated hardware. Further, although the example programs are described with reference to the flowcharts illustrated in FIGS. 7, 8A-8B, 9, 10, 11, 12, 13, and 14, many other methods of implementing the example system 100 may alternatively be used. For example, the order of execution of the blocks may be changed, and/or some of the blocks described may be changed, eliminated, or combined.

As mentioned above, the example processes of FIGS. 7, 8A-8B, 9, 10, 11, 12, 13, and 14 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and transmission media. As used herein, “tangible computer readable storage medium” and “tangible machine readable storage medium” are used interchangeably. Additionally or alternatively, the example processes of FIGS. 7, 8A-8B, 9, 10, 11, 12, 13, and 14 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and transmission media. As used herein, when the phrase “at least” is used as the transition term in a preamble of a claim, it is open-ended in the same manner as the term “comprising” is open ended.

FIG. 7 is a flowchart representative of example machine readable instructions 700 which, when executed, cause a logic circuit to estimate commercial characteristics of a commercial point of interest. The example instructions 700 may be executed by the system 100 of FIG. 1 based on receiving an area and/or point of interest 102 for which a characterization of its commercial ecosystem is desired.

The example image retriever 116 of FIG. 1 obtains an aerial image of a cPOI and/or cAOI 102 (block 702). For example, the image retriever 116 requests and receives an aerial image (e.g., the aerial image 502 including the point/area of interest 520 of FIG. 5) from the aerial image repository 112 via the network 114 of FIG. 1. The image retriever 116 also obtains associated aerial images of geographic areas surrounding the cPOI and/or cAOI 102 (block 704). For example, the image retriever 116 may determine a geographic area that potentially affects the commercial ecosystem of the cPOI and/or cAOI 102 based on empirical evidence, and request and receive additional aerial images (e.g., the aerial images 504-518 of FIG. 5) of the determined geographic area from the aerial image repository 112.

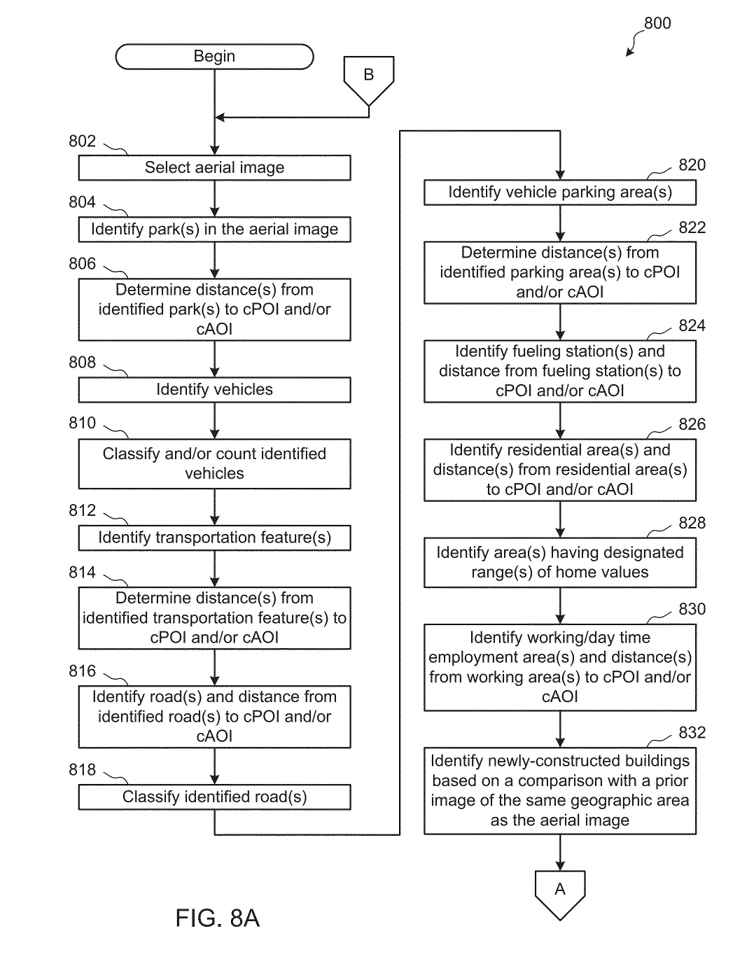

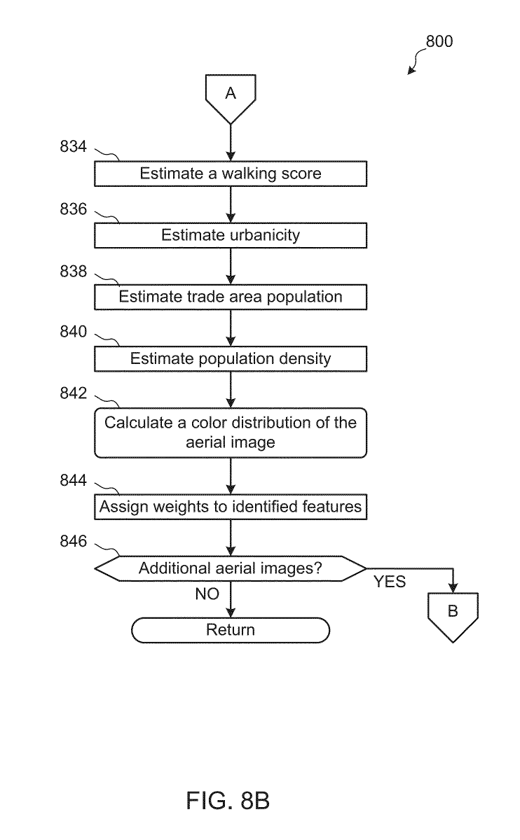

The example feature identifier 118 of FIG. 1 selects an aerial image (e.g., one of the aerial images 502-518) (block 706) and identifies contextual feature(s) present in the selected aerial image (block 708). For example, the feature identifier 118 may use computer vision and/or supplemental data to identify contextual features. Example contextual features identifiable via computer vision include, but are not limited to, public parks, buildings having designated type(s) (e.g., commercial, retail, residential, industrial, transportation, etc.), road(s), transportation features (e.g., railroad tracks, bus stops, etc.), observable vehicle(s), vehicle parking areas (e.g., parking lots), and/or fueling stations. In some cases, the feature identifier 118 derives contextual features from computer vision and/or supplemental data. Example supplemental data includes, but is not limited to, mapping service data, public real estate record data, traffic monitoring data, and/or mobile communications data. Example instructions to implement block 708 are disclosed below with reference to FIGS. 8A-8B, 12, 13, and/or 14.

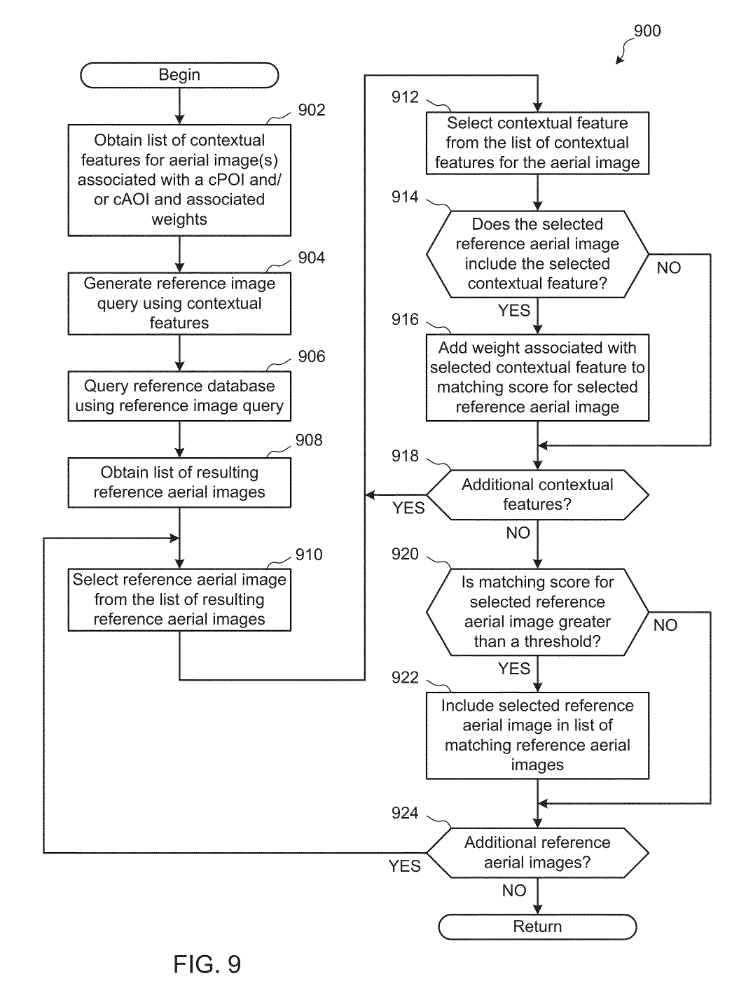

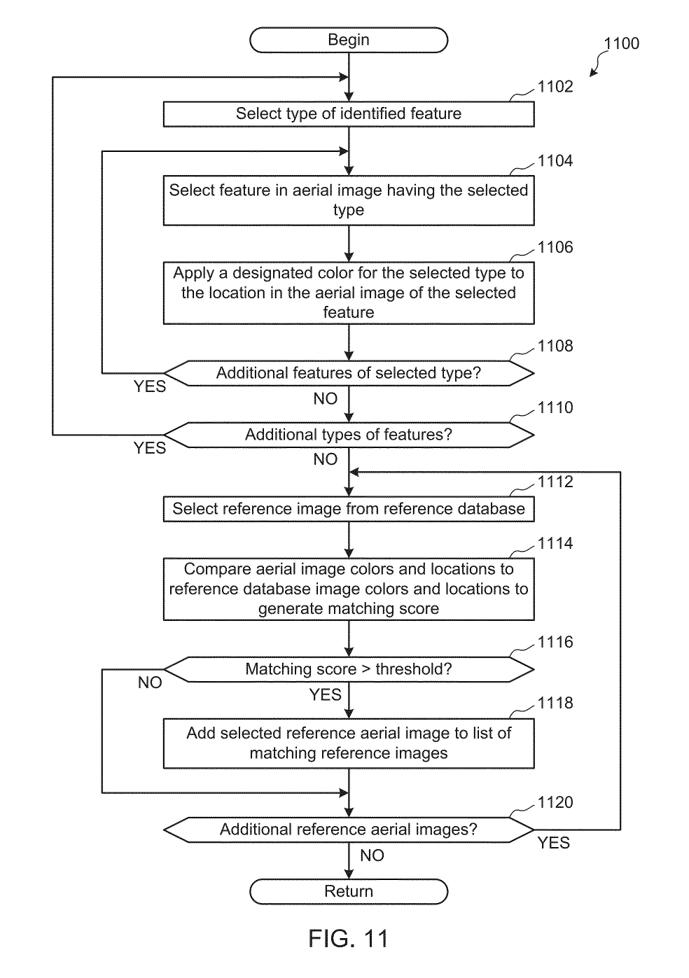

The example image comparator 106 of FIG. 1 identifies matching reference aerial image(s) having the identified contextual feature(s) (block 710). For example, the image comparator 106 queries the reference database 110 of FIG. 1 using the contextual feature(s) to obtain a list of reference aerial images having those features. The example image comparator 106 may determine the most closely-matching reference aerial images from the image(s) returned from the query. Example instructions to implement block 710 are disclosed below with reference to FIGS. 9 and 11.

The example point/area of interest classifier 108 of FIG. 1 determines commercial characteristics of the reference aerial image(s) identified by the image comparator 106 (block 712). For example, the point/area of interest classifier 108 may determine a set of commercial characteristics that are associated with at least a threshold number of the identified reference aerial image(s).

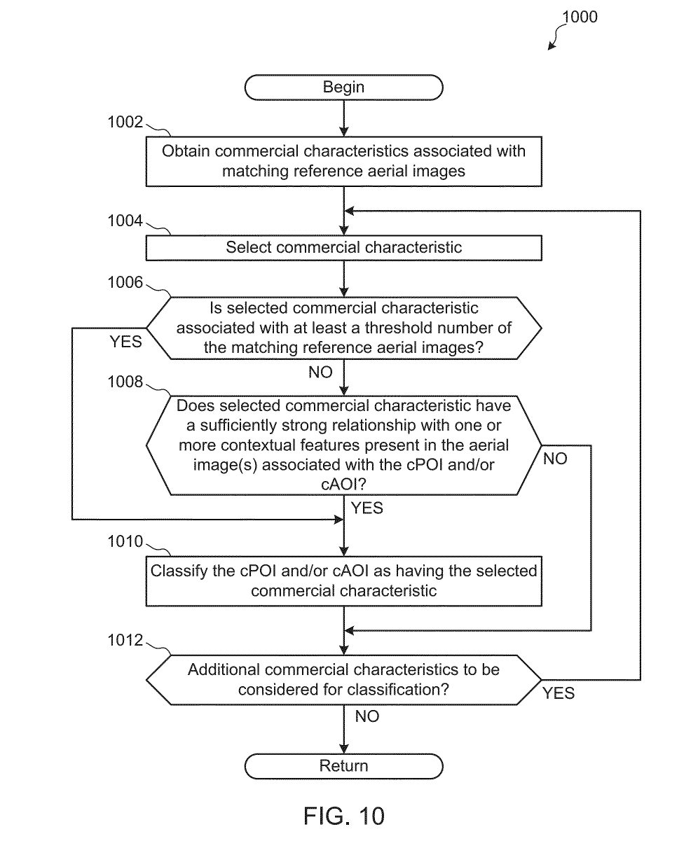

The feature identifier 118 determines whether there are additional aerial images (block 714). If there are additional aerial images (block 714), control returns to block 706 to select another of the aerial images. When there are no additional aerial images (block 714), the example point/area of interest classifier 108 estimates commercial characteristics of the cPOI and/or cAOI 102 based on the commercial characteristics of the identified reference aerial images (block 716). For example, the feature identifier 118 may classify the area and/or point of interest 102 with commercial characteristics determined from the identified matching reference aerial images. Example instructions to implement block 716 are disclosed below with reference to FIG. 10. After estimating the commercial characteristics of the cPOI and/or cAOI 102 (block 716), the example instructions 700 of FIG. 7 end.

FIGS. 8A and 8B collectively illustrate a flowchart representative of example machine readable instructions 800 which, when executed, cause a logic circuit to identify contextual features present in an aerial image of a commercial point of interest. The example instructions 800 of FIGS. 8A-8B may be performed by the example feature identifier 118 of FIGS. 1 and 2 to implement block 708 of FIG. 7 to identify contextual features from aerial images and/or using supplemental data. While blocks 802-846 are illustrated in an example order, any or all of the blocks 802-846 may be rearranged and/or omitted in other examples. The example feature identifier 118 of FIGS. 1 and 2 selects an aerial image (e.g., the aerial image 502 of FIG. 5) (block 802).

The example computer vision analyzer 202 of FIG. 2 identifies park(s) in the aerial image 502 (block 804). For example, the computer vision analyzer 202 may access the feature characteristics database 204 of FIG. 2 to determine visual characteristics of parks, and use computer vision to identify any parks in the aerial image using the visual characteristics. The example distance meter 210 determines the distance(s) from the identified park(s) to the cPOI and/or cAOI 102 (block 806). For example, the distance meter 210 may determine the distance(s) from the park(s) to the point/area of interest 520 based on the scale of the aerial image 502 and a number of pixels between a respective park and the point/area of interest 520.

The example computer vision analyzer 202 identifies vehicles in the aerial image (block 808). For example, the computer vision analyzer 202 may identify vehicles based on shape(s), size(s), color(s), and/or location(s) within the aerial image. The example computer vision analyzer 202 further classifies and/or counts the identified vehicles (block 810). Classification may be used to separate, for example, passenger cars and/or trucks from larger (e.g., cargo-hauling) trucks. The counts of the vehicles may be used to identify vehicle density for identifying and/or classifying roads and/or parking areas as discussed herein.

The example computer vision analyzer 202 identifies transportation feature(s) in the aerial image 502 (block 812). Example transportation features include train tracks, train stations (e.g., buildings adjacent roads and train tracks) and/or bus stops (e.g., small shelters or buildings adjacent roads and which may be on walkways). In some examples, the derived feature calculator 206 determines transportation features based on supplemental data (e.g., map data) and the computer vision analysis performed by the computer vision analyzer 202. The example distance meter 210 determines distance(s) from the identified transportation feature(s) to the cPOI and/or cAOI 102 (block 814). For example, the example distance meter 210 may determine the shortest distance(s) from identified train tracks to the point/area of interest 520 and/or determine the distance from the train tracks based on a distance to a closest identified train station associated with the train tracks.

The example computer vision analyzer 202 identifies road(s) and distance(s) from the identified road(s) to the cPOI and/or cAOI 102 (block 816). For example, the computer vision analyzer 202 may use road characteristics obtained from the feature characteristics database 204 to inform computer vision techniques (e.g., bag of words, etc.) for identifying roads in the aerial image 502. The example distance meter 210 identifies a distance, such as the shortest distance, between each identified road and the cPOI and/or cAOI 102. The example distance meter 210 may determine distance by determining the number of pixels between the identified road and the point/area of interest 520 in the vertical (e.g., longitudinal) and horizontal (e.g., latitudinal) directions, calculating the number of pixels over the hypotenuse, and multiplying the resulting number of pixels by the scale. The example computer vision analyzer 202 classifies the identified road(s) (block 818). For example, the computer vision analyzer 202 classifies the identified road(s) based on width(s) of the road(s), color(s) of the road(s), and/or number(s) of vehicles identified on the road(s). For example, the computer vision analyzer 202 may identify one or more highways by the presence of cloverleaf-shaped interchanges near the intersection of two identified road(s).

The example computer vision analyzer 202 identifies vehicle parking area(s) in the aerial image 502 (block 820). For example, the computer vision analyzer 202 may identify areas that have a high density of vehicles but are not roads (e.g., do not have the extended shape of a road). The example distance meter 210 determines the distance(s) from the identified vehicle parking area(s) to the cPOI and/or cAOI 102 (block 822). The example distance meter 210 may determine distance between the parking area and the point/area of interest 520 by determining the number of pixels between the identified road and the point/area of interest 520 in the vertical (e.g., longitudinal) and horizontal (e.g., latitudinal) directions, calculating the number of pixels over the hypotenuse, and multiplying the resulting number of pixels by the scale.

The example computer vision analyzer 202 identifies fueling station(s) (or recharge station(s)) in the example aerial image 502 and the distance meter 210 determines the distance(s) from the identified fueling station(s) to the cPOI and/or cAOI 102 (block 824). For example, the computer vision analyzer 202 may identify fueling stations based on the pattern of structures and/or based on a shape and/or color indicative of a canopy over the fueling station. Different geographic areas may have different requirements (e.g., local regulatory requirements) of fueling stations. The example feature characteristics database 204 stores visual cues resulting from such requirements for use by the computer vision analyzer 202.

The example computer vision analyzer 202 identifies residential area(s) and the distance meter 210 determines distance(s) from the residential area(s) to the cPOI and/or cAOI 102 (block 826). The example distance meter 210 may determine distance between the residential area and the point/area of interest 520 by determining the number of pixels between the identified road and the point/area of interest 520 in the vertical (e.g., longitudinal) and horizontal (e.g., latitudinal) directions, calculating the number of pixels over the hypotenuse, and multiplying the resulting number of pixels by the scale.

The example computer vision analyzer 202 identifies area(s) having designated range(s) of home values (block 828). For example, the computer vision analyzer 202 may identify elements in the image that are indicative of higher or lower home values, such as building density, the presence of luxury features such as swimming pools, distance(s) to designated high-desirability locations and/or low-desirability locations, and/or other factors.

The example computer vision analyzer 202 identifies working area(s) and/or day time employment area(s), and the distance meter 210 determines the distance(s) from the working area(s) and/or day time employment area(s) to the cPOI and/or cAOI 102 (block 830). The example distance meter 210 may determine distance between the working area and the point/area of interest 520 by determining the number of pixels between the identified road and the point/area of interest 520 in the vertical (e.g., longitudinal) and horizontal (e.g., latitudinal) directions, calculating the number of pixels over the hypotenuse, and multiplying the resulting number of pixels by the scale.

The example computer vision analyzer 202 identifies newly-constructed buildings (or other features) by comparing the aerial image with another aerial image of the same geographic area from a previous time period (block 832). For example, the image retriever 116 of FIG. 1 may request and receive multiple aerial images for a geographic area that correspond to images taken at different times. In some examples, the received images are taken at least 6 months apart. However, other intervals may be used.

Turning to FIG. 8B, the example derived feature calculator 206 estimates a walking score for the area associated with the aerial image (block 834). As discussed above, a walking score represents a measure of the extent to which necessities, amenities, and/or luxuries are within a threshold distance of an area or point. The example derived feature calculator 206 estimates a walking score based on, for example, the identification of schools, churches, and/or grocery stores, the identification of public parks, and/or the identification of other commerce by the computer vision analyzer 202 and the distances of the identified features to the area and/or point of interest 102.

The example derived feature calculator 206 also estimates an urbanicity (e.g., an urbanicity score) for the area associated with the aerial image (block 836). The example derived feature calculator 206 determines the urbanicity score based on features detected by the computer vision analyzer 202, information derived from the features visually detected by the computer vision analyzer 202, and/or supplemental information obtained via the supplemental data retriever 208. In some examples, the urbanicity score is calculated based on features identified by the computer vision analyzer 202, such as the road accessibility (e.g., how many paths there are to get to the area and/or point of interest 102), counts of total buildings, counts of commercial buildings, counts of households, daytime population (e.g., the estimated count of people present in the area or around the area and/or point of interest 102 during daytime or working hours), number of ways to get to the area and/or point of interest 102 using public transit, and/or a driving score.

The example derived feature calculator 206 estimates a trade area population for the area associated with the aerial image (block 838). The trade area population refers to a number of people that may be considered as potential patrons of a retail establishment or, in other words, a number of people within an area who would visit the retail establishment for a product or service. For example, the derived feature calculator 206 may determine the trade area population based on the residential population and/or the daytime population within a threshold distance.

The example derived feature calculator 206 estimates a population density for the area associated with the aerial image (block 840). For example, the derived feature calculator 206 may apply an average population density to residential buildings based on the observed building densities, building types, and/or estimated residential building values (e.g., home values). Using measurements of the area that include residential buildings, the example derived feature calculator 206 estimates the population within a distance of the area and/or point of interest 102.

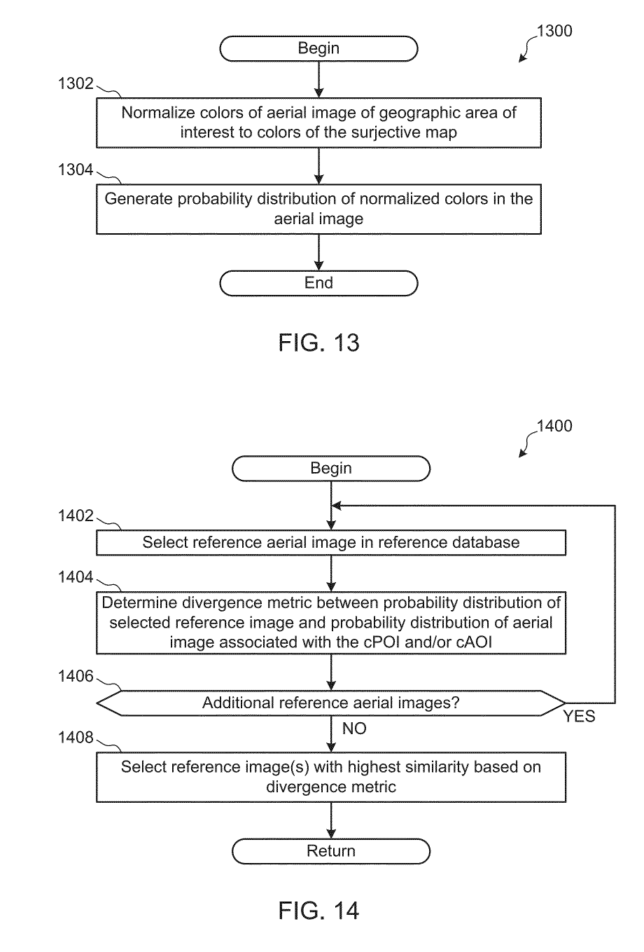

The example color feature analyzer 214 of FIGS. 2 and 3 calculates a color distribution of the aerial image (block 842). For example, the color feature analyzer 214 generates a distribution of the colors (original or normalized colors) found in the aerial image that may be compared to the distributions of colors found in the reference images. Example instructions to implement block 842 are described below with reference to FIG. 13.

The example feature weighter 212 of FIG. 2 assigns weights to the identified features (block 844). In some examples, the feature weighter 212 may determine a weight of a feature based on the type of the feature (e.g., certain features weigh more heavily than other features for matching aerial images and/or for characterizing the cPOI and/or cAOI) and/or based on the distance between the identified feature and the area and/or point of interest 102 calculated by the distance meter 210.

The example feature identifier 118 determines whether there are additional aerial images in which features are to be identified (block 846). If there are additional images (block 846), control returns to block 802 of FIG. 8A to select another aerial image. When there are no additional images (block 846), the example instructions 800 of FIGS. 8A-8B end and return control to block 710 of FIG. 7.

FIG. 9 is a flowchart representative of example machine readable instructions 900 which, when executed, cause a logic circuit to identify one or more reference aerial images (e.g., the reference aerial images 602-618 of FIG. 6) having contextual features identified in an aerial image (e.g., the aerial images 502-518 of FIG. 5) of a commercial point of interest (e.g., the point/area of interest 520). The example instructions 900 of FIG. 9 may be executed to implement the example image comparator 106 of FIGS. 1 and/or 4.

The example image comparator 106 (e.g., via the query generator 402 of FIG. 4) obtains a list of contextual features for the aerial image(s) associated with a cPOI and/or cAOI 102 (e.g., the images 502-518 for the point/area of interest 520 of FIG. 5) and associated weights (block 902). In the example of FIG. 9, the contextual features in the list are identified from the aerial image 502 including the point/area of interest 520 and from the aerial images 504-518 of the geographic areas surrounding the point/area of interest 520. In other examples, the contextual features may be determined from only the aerial image 502 including the point/area of interest 520. In some examples, one or more contextual features may be determined from an area surrounding the point/area of interest 520 larger than the area represented by the images 502-518 from which the other features are identified. For example, a contextual feature may include a type or classification of the local municipality, which may be a larger area than the area from which features are identified using computer vision techniques.

The query generator 402 generates a reference image query using the contextual features (block 904). For example, the query generator 402 generates a query for execution on the reference database 110 that may request aerial images having those features that are present in the list of contextual features and have at least a threshold weight. In some other examples, the query requests aerial images that have the top X weighted features in the list of contextual features. In some other examples, the query generator 402 generates a query with a most highly-weighted feature, receives the results, generates a second query on the first results using the second most highly-weighted feature, receives the results, and so on until a list of less than a threshold number of reference aerial images is obtained.

The example query generator 402 queries the reference database 110 using the generated query (block 906) and obtains a list of resulting reference aerial images (e.g., the reference aerial images 602-618 and/or other reference aerial images) from the reference database (block 908).

The example feature comparator 404 of FIG. 4 selects a reference aerial image 600 and/or 602-618 from the list of resulting reference aerial images (block 910). The feature comparator 404 also selects a contextual feature from the list of contextual features for the aerial image 502 (block 912). The example feature comparator 404 of FIG. 4 determines whether the selected reference aerial image 600 includes the selected contextual feature (block 914). The example feature comparator 404 may determine whether the selected reference aerial image 600 includes the selected contextual feature by determining whether the feature is listed in metadata associated with the selected reference aerial image 600 in the reference database 110.

If the selected reference aerial image 600 includes the selected contextual feature (block 914), the example matching score calculator 406 adds the weight associated with the selected contextual feature to a matching score for the selected reference aerial image (block 916). For example, because the reference aerial image 600 includes a public park feature present in the image(s) 502-518 of FIG. 5, the example matching score calculator 406 adds a weight assigned to a public park by the feature weighter 212 of FIG. 2 to a matching score for the reference aerial image 600.

After adding the weight to the matching score (block 916), or if the selected reference aerial image 600 does not include the selected contextual feature (block 914), the example feature comparator 404 determines whether there are additional contextual features for which the reference image 600 is to be searched (block 918). If there are additional contextual features (block 918), control returns to block 912 to select another contextual feature.

When there are no more contextual features to be searched in the selected reference aerial image (block 918), the example matching score calculator 406 determines whether the matching score for the selected reference aerial image 600 is greater than a threshold (block 920). If the matching score for the selected reference aerial image 600 is greater than a threshold (block 920), the example matching score calculator 406 includes the selected reference aerial image 600 in a list of matching reference aerial images (block 922). The list of matching reference aerial images is provided by the image comparator 106 to the point/area of interest classifier 108 for classifying the commercial characteristics of the point/area of interest 520.

After including the selected reference aerial image 600 in the list of matching reference aerial images (block 922), or if the matching score is not greater than the threshold (block 920), the example feature comparator 404 determines whether there are additional reference aerial images in the list of results from the query (block 924). If there are additional reference aerial images (block 924), the example

FIG. 10 is a flowchart representative of example machine readable instructions 1000 which, when executed, cause a logic circuit to estimate commercial characteristics of a commercial point of interest (e.g., the example point/area of interest 520 of FIG. 5). The example instructions 1000 may be executed by the example point/area of interest classifier 108 of FIG. 1 to implement block 716 of FIG. 7.

The example point/area of interest classifier 108 obtains the commercial characteristics associated with the matching reference aerial images (block 1002). For example, the point/area of interest classifier 108 may request and receive the commercial characteristics from the reference database 110 based on querying the reference database 110 with an identification of the matching reference aerial images.

The example point/area of interest classifier 108 selects one of the commercial characteristics (block 1004) and determines whether the selected commercial characteristic is associated with at least a threshold number of the matching reference aerial images (block 1006). In some examples, the threshold number is based on the number of matching reference aerial images, such as in a majority voting scheme. In some examples, the threshold number is based on the highest X number of commercial characteristics represented in the reference aerial images (e.g., the top ten commercial characteristics, or any other number).

If the selected commercial characteristic is not associated with at least a threshold number of matching reference aerial images (block 1006), the example point/area of interest classifier 108 determines whether the selected commercial characteristic has a sufficiently strong relationship (e.g., an empirically and/or theoretically determined relationship) with one or more of the contextual features present in the aerial image(s) associated with the cPOI and/or cAOI 102 (block 1008). For example, the point/area of interest classifier 108 may determine that the presence of a high daytime population (e.g., a daytime population greater than a threshold) near the point/area of interest 520 is strongly associated with a high demand for convenience stores (e.g., a demand for products associated with convenience stores that is greater than a threshold). If few of the reference aerial images are associated with a high demand for convenience stores but the aerial image(s) are determined to have a high daytime population, the point/area of interest classifier 108 of this example classifies the point/area of interest 520 as having a high demand for convenience stores.

If the selected commercial characteristic is associated with at least a threshold number of matching reference aerial images (block 1006) or if the selected commercial characteristic has a sufficiently strong relationship with any of the contextual features present in the aerial image(s) associated with the cPOI and/or cAOI 102 (block 1008), the example point/area of interest classifier 108 classifies the cPOI and/or cAOI 102 as having the selected commercial characteristic (block 1010). For example, the point/area of interest classifier 108 may add the commercial characteristic to a point of interest classification output.

After classifying the cPOI and/or cAOI 102 as having the selected commercial characteristic (block 1010), or if the selected commercial characteristic is not associated with at least a threshold number of matching reference aerial images (block 1006) and the selected commercial characteristic does not have a sufficiently strong relationship with any of the contextual features present in the aerial image(s) associated with the point/area of interest 520 (block 1008), the example point/area of interest classifier 108 determines whether there are additional commercial characteristics to be considered for classification (block 1012). If there are additional commercial characteristics to be considered (block 1012), control returns to block 1004 to select another commercial characteristic. When there are no more commercial characteristics to be considered for classification (block 1012), the example instructions 1000 end and return control to the instructions 700 of FIG. 7.

FIG. 11 is a flowchart representative of example machine readable instructions 1100 which, when executed, cause a logic circuit to identify one or more reference aerial images (e.g., the reference aerial images 602-618 of FIG. 6) having contextual features identified in an aerial image (e.g., the aerial images 502-518 of FIG. 5) of a commercial point of interest (e.g., the point/area of interest 520). The example instructions 1100 of FIG. 11 may executed to implement the example image comparator 106 of FIGS. 1 and/or 4, and/or as an alternative implementation to the instructions 900 of FIG. 9.

The example image comparator 106 (e.g., via the feature encoder 408 of FIG. 4) selects a type of identified feature (block 1102). For example, the feature encoder 408 selects a feature type from the list of features identified in the aerial images 502-518. The example feature encoder 408 selects one of the feature(s) in the aerial image(s) 502-518 having the selected feature type (block 1104). For example, there may be multiple occurrences of a same type of contextual feature in the aerial images 502-518.

The example feature encoder 408 applies a designated color for the selected type to the location in the aerial image 502-518 of the selected feature (block 1106). For example, if a public park feature is associated with a designated shade of green, the example feature encoder 408 includes a feature of the designated shade (e.g., a pixel, a shape including multiple pixels, etc.) at the location of the park (e.g., at the center of the park, at the point in the park closest to the point/area of interest 520, etc.). If the selected type is associated with an area (e.g., a residential area, a commercial area, etc.), the example feature encoder 408 may encode the designated color at a deterministically-selected location in the area associated with the feature. If the selected feature is a numerical characteristic of the area and/or point of interest 102 and/or an area surrounding and/or near the point/area of interest 520, the feature encoder 408 may, for example, encode a color on or near the point/area of interest 520 that is associated with the selected type of feature and/or a range of the numerical value determined for the feature. For example, a daytime population of 10,000-50,000 may be associated with a designated shade of red, in which case the feature encoder 408 encodes one or more pixels in the aerial image 502 with the shade of red when the daytime population feature is determined to fall within the 10,000-50,000 range.

After applying the designated color (block 1106), the example feature encoder 408 determines whether there are additional features of the selected type (block 1108). If there are additional features of the selected type (block 1108), control returns to block 1104 to select another of the features. If there are no more features of the selected type (block 1108), the example feature encoder 408 determines whether there are additional types of features (block 1110). If there are additional types of features (block 1110), control returns to block 1102 to select another type of feature.

When there are no more types of features (block 1110), the example feature comparator 404 selects a reference image (e.g., the image 600) from the reference database 110 (block 1112). In the example of FIG. 11, the reference aerial images 600 in the reference database 110 have been pre-encoded based on the features present in the reference aerial images 600 in the manner described with reference to blocks 1102-1110. The example feature comparator 404 and/or the matching score calculator 406 compares the aerial image colors and/or locations to the reference database image colors and/or locations to generate a matching score (block 1114). For example, the feature comparator 404 may determine a correlation coefficient or other similarity value based on the colors and/or distances between the two images using the colors assigned to features (e.g., ignoring other colors in the images).

The example matching score calculator 406 determines whether the matching score is greater than a threshold (block 1116). The threshold may be an empirically-determined and/or geographically-dependent value. If the matching score is greater than the threshold value (block 1116), the example matching score calculator 406 adds the selected reference aerial image to the list of matching reference images (block 1118). After adding the selected reference aerial image to the list of matching reference images (block 1118), or if the matching score is not greater than the threshold (block 1116), the example matching score calculator 406 determines whether there are additional reference aerial images for comparison (e.g., in the reference database 110) (block 1120). If there are additional reference aerial images for comparison (block 1120), control returns to block 1112 to select another reference image. When there are no more reference aerial images to be compared (block 1120), the example instructions 1100 of FIG. 11 end and control returns to block 712 of FIG. 7.

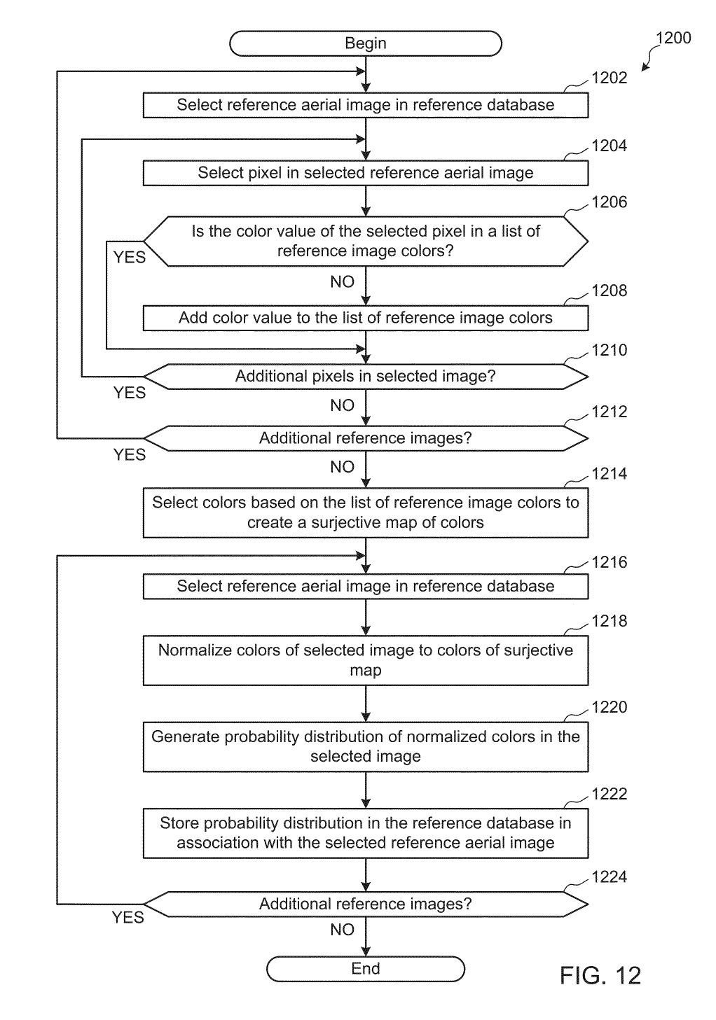

FIG. 12 is a flowchart representative of example machine readable instructions 1200 which, when executed, cause a logic circuit to determine color features of reference images for comparison with color features of an aerial image. The example instructions 1200 of FIG. 12 may be executed by the color feature analyzer 214 of FIGS. 2 and/or 3 to enable detection of color features in aerial images and/or to prepare the reference aerial images of geographic areas having known commercial characteristics. In general, in blocks 1202-1216, the example color feature analyzer 214 analyzes the reference aerial images to create a surjective color map. In blocks 1218-1224, the example color feature analyzer 214 processes the reference aerial images to conform the reference aerial images to the surjective color map to provide a consistent set of colors to which aerial images of commercial points of interest may be compared.

The example color feature analyzer 214 (e.g., via the example image color reducer 302 of FIG. 3) selects a reference aerial image in the reference database 110 of FIG. 1 (block 1202). The example image color reducer 302 selects a pixel in the selected reference aerial image (block 1204). The image color reducer 302 determines whether the color value of the selected pixel (e.g., an RGB value) is in a list of reference image colors (block 1206). The list of reference image colors includes the color values that have been identified in the pixels of reference aerial images during the processing (e.g., iteration) of blocks 1202-1212.

If the color value of the selected pixel is not in the list of reference image colors (block 1206), the example image color reducer 302 adds the color value to the list of reference image colors (block 1208). After adding the color value (block 1208) or if the color value is already in the list of reference image colors (block 1206), the example image color reducer 302 determines whether there are additional pixels in the selected image (block 1210). If there are additional pixels (block 1210), control returns to block 1204 to select another pixel. When there are no additional pixels (block 1210), the example image color reducer 302 determines whether there are additional reference images (block 1212). If there are additional reference images (block 1212), control returns to block 1202 to select another reference aerial image.

When there are no more reference aerial images (e.g., the image color reducer 302 has processed the pixels of all of the reference aerial images in the reference database 110), the example image color reducer 302 selects colors based on the list of reference image colors to create a surjective map of colors (block 1214). For example, the image color reducer 302 may select a set of 256 colors (or another number of colors) that each are to represent a set of color values that are in the list of reference image colors. As an example, if the list of reference image colors includes 256,000 separate RGB color values (e.g., three-tuples having values 0-255, 0-255, 0-255), the representative color values for the surjective map are selected such that each map color value represents 1,000 of the color values in the list. Additionally, the example image color reducer 302 of FIG. 3 selects the representative color to appear similar to the colors being represented by the representative color (e.g., selects one of the colors being represented).

The example image color reducer 302 selects a reference aerial image from the reference database 110 (block 1216). In the example of FIG. 12, the reference aerial image selected in block 1216 is an image that was selected in an iteration of blocks 1202-1212. The example image color reducer 302 normalizes the colors of the selected image to the colors of the surjective map (block 1218). For example, for each of the pixels in the selected reference aerial image, the example image color reducer 302 replaces the original color value of the image with the color value in the surjective map to which the original color value is mapped.

The example color distribution generator 304 of FIG. 3 generates a probability distribution of the normalized colors (e.g., a color distribution) in the selected image (block 1220). Thus, the example color distribution for a reference aerial image reflects the respective frequencies of each of the colors in the surjective map occurring in the normalized colors of the reference aerial image. The example color distribution generator 304 stores the generated color distribution as a feature associated with the selected reference aerial image in the reference database 110 (block 1222).

The example image color reducer 302 determines whether there are additional reference aerial images for which probability distributions are to be generated and/or stored as features (block 1224). If there are additional reference aerial images (block 1224), control returns to block 1216 to select another reference aerial image. When there are no more reference aerial images (block 1224), the example instructions 1200 of FIG. 12 end and the color feature analyzer 214 awaits a request to analyze color features of an aerial image associated with a commercial point of interest.

FIG. 13 is a flowchart representative of example machine readable instructions 1300 which, when executed, cause a logic circuit to identify color features of an aerial image. The example color feature analyzer 214 of FIGS. 2 and 3 may execute the instructions 1300 to implement, for example, block 842 of FIG. 8B.

The example image color reducer 302 of FIG. 3 normalizes the colors of the aerial image (e.g., the aerial image(s) 502-518 of FIG. 5) associated with a commercial point of interest (e.g., the point/area of interest 520) using the colors in the surjective map (block 1302). For example, the image color reducer 302 uses a surjective map representative of the reference aerial images in the reference database 110 and created using the example instructions 1200 of FIG. 12. The example image color reducer 302 may execute block 1302 in the same manner as described above with reference to block 1218 of FIG. 12.

The example color distribution generator 304 generates a probability distribution of the normalized colors in the aerial image (e.g., a color distribution) (block 1304). The example color distribution generator 304 may execute block 1304 in the same manner as described above with reference to block 1220 of FIG. 12. The resulting color distribution of the aerial image 502-518 represents the proportion of the surjective image colors in the normalized aerial image. The example instructions 1300 of FIG. 13 then end and return control to block 844 of FIG. 8.

FIG. 14 is a flowchart representative of example machine readable instructions 1400 which, when executed, cause a logic circuit to identify reference images based on a color feature of an aerial image. The example color feature analyzer 214 of FIGS. 2 and/or 3 may execute the instructions 1400 to at least partially implement block 914 of FIG. 9 to determine whether a reference aerial image has a same color-based contextual feature as an aerial image associated with the point of interest.

The example comparison metric calculator 306 of FIG. 3 selects a reference aerial image in the reference database 110 (block 1402). The comparison metric calculator 306 determines a divergence metric (e.g., a similarity value) between the probability distribution (e.g., color distribution) of the selected reference aerial image and the probability distribution (e.g., color distribution) of the aerial image associated with the cPOI and/or cAOI 102 (block 1404). For example, the comparison metric calculator 306 may determine the divergence metric as a square root of the Jensen-Shannon divergence of the color distributions.

The comparison metric calculator 306 determines whether there are additional reference aerial images for comparison (block 1406). If there are additional reference aerial images (block 1406), control returns to block 1402 to select another reference aerial images.

When there are no more reference aerial images (e.g., comparison metrics have been created for each of the reference aerial images in the reference database 110) (block 1406), the example metric evaluator 308 of FIG. 3 selects reference image(s) that have the highest similarities with the aerial image based on the divergence metric (block 1408). For example, a lower metric indicates a higher similarity where the metric is the square root of the Jensen-Shannon divergence. Thus, in some examples the metric evaluator 308 selects the reference image(s) having the lowest metrics and/or the reference aerial image(s) having metrics less than a threshold. The selected reference aerial image(s) may be returned as reference aerial image(s) having the same color-based contextual feature as the aerial image(s) under consideration.

After selecting the reference image(s) (block 1408), the example instructions 1400 end and return control to block 916 of FIG. 9.

FIG. 16 is a block diagram of an example processor platform 1600 capable of executing the instructions of FIGS. 7, 8A-8B, 9, 10, 11, 12, 13, and/or 14 to implement the example image analyzer 104, the example image comparator 106, the example point/area of interest classifier 108, the example reference database 110, the example image retriever 116, the example feature identifier 118, the example image combiner 120, the example computer vision analyzer 202, the example feature characteristics database 204, the example derived feature calculator 206, the example supplemental data retriever 208, the example distance meter 210, the example feature weighter 212, the example image color reducer 302, the example color distribution generator 304, the example comparison metric calculator 306, the example metric evaluator 308, the example color balancer 310, the example query generator 402, the example feature comparator 404, the example match score calculator 406 and/or, more generally, the example system 100 of FIGS. 1, 2, 3, and/or 4. The processor platform 1600 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The processor platform 1600 of the illustrated example includes a processor 1612. The processor 1612 of the illustrated example is hardware. For example, the processor 1612 can be implemented by one or more integrated circuits, logic circuits, microprocessors or controllers from any desired family or manufacturer.

The processor 1612 of the illustrated example includes a local memory 1613 (e.g., a cache). The processor 1612 of the illustrated example is in communication with a main memory including a volatile memory 1614 and a non-volatile memory 1616 via a bus 1618. The volatile memory 1614 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1616 may be implemented by flash memory and/or any other desired type of memory device. Access to the main memory 1614, 1616 is controlled by a memory controller.

The processor platform 1600 of the illustrated example also includes an interface circuit 1620. The interface circuit 1620 may be implemented by any type of interface standard, such as an Ethernet interface, a universal serial bus (USB), and/or a PCI express interface.

In the illustrated example, one or more input devices 1622 are connected to the interface circuit 1620. The input device(s) 1622 permit(s) a user to enter data and commands into the processor 1612. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1624 are also connected to the interface circuit 1620 of the illustrated example. The output devices 1624 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 1620 of the illustrated example, thus, typically includes a graphics driver card, a graphics driver chip or a graphics driver processor.

The interface circuit 1620 of the illustrated example also includes a communication device such as a transmitter, a receiver, a transceiver, a modem and/or network interface card to facilitate exchange of data with external machines (e.g., computing devices of any kind) via a network 1626 (e.g., an Ethernet connection, a digital subscriber line (DSL), a telephone line, coaxial cable, a cellular telephone system, etc.).

The processor platform 1600 of the illustrated example also includes one or more mass storage devices 1628 for storing software and/or data. Examples of such mass storage devices 1628 include floppy disk drives, hard drive disks, compact disk drives, Blu-ray disk drives, RAID systems, and digital versatile disk (DVD) drives.

The coded instructions 1632 of FIGS. 7, 8A-8B, 9, 10, 11, 12, 13, and 14 may be stored in the mass storage device 1628, in the volatile memory 1614, in the non-volatile memory 1616, and/or on a removable tangible computer readable storage medium such as a CD or DVD.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method, comprising:
identifying, using a computer vision technique executed by a processor, a feature in a first aerial image of a geographic location of interest;
identifying, using the processor, a reference aerial image that includes the feature from a set of reference aerial images, the reference aerial image being associated with commercial characteristics; and
associating a first one of the commercial characteristics with the location of interest.

2. A method as defined in claim 1, wherein the identifying of the feature is based on at least one of a shape of an object in the first aerial image, a color in the first aerial image, a texture in the first aerial image, a count of objects in the first aerial image, or a density of objects in the first aerial image.

3. A method as defined in claim 1, wherein the identifying of the feature further comprises identifying at least one of a public park in the first aerial image, a building having a designated type in the first aerial image, a road in the first aerial image, a transportation feature in the first aerial image, a count of observed vehicles in the first aerial image, a vehicle parking area in the first aerial image, a fueling station in the first aerial image, a residential area in the first aerial image, a commercial area in the first aerial image, or a daytime employment area in the first aerial image.

4. A method as defined in claim 1, further comprising identifying a second feature using at least one of mapping service data, public real estate record data, traffic monitoring data, and/or mobile communications data to identify the feature.

5. A method as defined in claim 4, wherein the identifying of the reference aerial image is based on identifying the reference aerial image as having the second feature.

6. A method as defined in claim 5, wherein the second feature comprises at least one of an urbanicity, a walkability, a driving score, or daytime employment.

7. A method as defined in claim 1, further comprising:
generating a modified aerial image by modifying pixel colors of the first aerial image based on a surjective map of colors; and
calculating a color distribution of the modified aerial image, wherein the identifying the reference aerial image further comprises comparing a divergence metric to a threshold, the divergence metric based on the color distribution of the modified aerial image, and the color distribution determined based on the reference aerial image and the surjective map of colors.

8. A method as defined in claim 1, further comprising:
generating a representation of the first aerial image based on the feature, the representation comprising a pixel color corresponding to the feature, wherein the identifying of the reference aerial image further comprises comparing the pixel color present in the representation of the first aerial image to pixel colors present in representations of the set of reference images.

9. A method as defined in claim 1, further comprising weighting the feature based on a type of the feature, the identifying of the reference image being based on the weight of the feature.

10. A method as defined in claim 1, wherein the identifying of the reference aerial image further comprises querying a reference database based on the feature, the reference database comprising sets of features associated with respective images of the set of reference aerial images.

11. A method as defined in claim 1, further comprising determining whether the reference aerial image matches the first aerial image based on a comparison of a first set of features of the first aerial image to a second set of features of the reference aerial image, the first set of features including the first feature, wherein the associating of the first one of the commercial characteristics with the location of interest is in response to determining that the reference aerial image matches the first aerial image.

12. An apparatus, comprising:
a computer vision analyzer to identify a first feature in a first aerial image of a geographic location of interest;
an image comparator to identify a reference aerial image from a set of reference aerial images, the reference aerial image including the first feature and being associated with a commercial characteristic; and
a classifier to associate the commercial characteristic with the location of interest.

13. An apparatus as defined in claim 12, further comprising a feature database to store potential feature information, the computer vision analyzer to access the feature database to analyze the first aerial image.

14. An apparatus as defined in claim 12, further comprising a derived feature calculator to identify a second feature associated with the first aerial image based on the first feature and supplemental data associated with the location.

15. An apparatus as defined in claim 14, wherein the second feature comprises at least one of an urbanicity, a walkability, a driving score, or daytime employment.

16. An apparatus as defined in claim 12, wherein the first feature comprises at least one of a public park in the first aerial image, a building having a designated type in the first aerial image, a road in the first aerial image, a transportation feature in the first aerial image, a count of observed vehicles in the first aerial image, a vehicle parking area in the first aerial image, a fueling station in the first aerial image, a residential area in the first aerial image, a commercial area in the first aerial image, or a daytime employment area in the first aerial image.

17. An apparatus as defined in claim 12, further comprising a feature weighter to apply a weight to the first feature based on a type of the first feature.

18. An apparatus as defined in claim 17, further comprising a distance meter to determine a distance between the first feature and the location of interest based on a scale of the aerial image, the feature weighter to apply the weight to the first feature based on the distance.

19. An apparatus as defined in claim 12, further comprising a color feature analyzer to identify the first feature based on colors present in the aerial image.

20. An apparatus as defined in claim 19, wherein the color feature analyzer comprises an image color reducer to map the colors in the aerial image to a surjective color map comprising mapped colors, the color feature analyzer to determine the first feature based on the mapped colors.

21. An apparatus as defined in claim 19, wherein the color feature analyzer comprises a color distribution generator to generate a probability distribution of colors associated with the aerial image.

22. An apparatus as defined in claim 21, wherein the color feature analyzer further comprises a comparison metric calculator to calculate a similarity value based on a divergence of the probability distribution associated with the aerial image and a second probability distribution associated with the reference aerial image.

23. An apparatus as defined in claim 19, wherein the color feature analyzer comprises a color balancer to adjust the colors present in the aerial images based on at least one of a time of year during which the aerial image was captured or a geographic area.

24. An apparatus as defined in claim 12, wherein the image comparator comprises a query generator to generate a query to query the set of reference aerial images, the query generator to generate the query based on the first feature.

25. An apparatus as defined in claim 12, wherein the image comparator comprises:
a feature comparator to compare a first set of features of the first aerial image to a second set of features of the reference aerial image, the first set of features including the first feature; and
a match score calculator to determine whether the reference aerial image matches the first aerial image based on a comparison of the first set of features to the second set of features.

26. A computer readable storage medium comprising computer readable instructions which, when executed, cause a logic circuit to at least:
identify a feature in a first aerial image of a geographic location of interest;
identify a reference aerial image that includes the feature from a set of reference aerial images, the reference aerial image being associated with commercial characteristics; and
associate a first one of the commercial characteristics with the location of interest.

27. A storage medium as defined in claim 26, wherein the instructions are to cause the logic circuit to identify the feature based on at least one of a shape of an object in the first aerial image, a color in the first aerial image, a texture in the first aerial image, a count of objects in the first aerial image, or a density of objects in the first aerial image.

28. A storage medium as defined in claim 26, wherein the instructions are to cause the logic circuit to identify the feature by:
generating a modified aerial image by modifying pixel colors of the first aerial image based on a surjective map of colors; and
calculating a color distribution of the modified aerial image.

29. A storage medium as defined in claim 28, wherein the instructions are to cause the logic circuit to identify the reference aerial image by comparing a divergence metric to a threshold, the divergence metric based on the color distribution of the modified aerial image and a color distribution determined based on the reference aerial image and the surjective map of colors.

30. A storage medium as defined in claim 26, wherein the instructions are further to cause the logic circuit to weight the feature based on a type of the feature, the identifying the reference image being based on the weight of the feature.

31. A storage medium as defined in claim 26, wherein the instructions are to cause the logic circuit to identify the reference aerial image by querying a reference database based on the feature, the reference database comprising sets of features associated with respective images of the set of reference aerial images.

32. A storage medium as defined in claim 26, wherein the instructions are to cause the logic circuit to determine whether the reference aerial image matches the first aerial image based on a comparison of a first set of features of the first aerial image to a second set of features of the reference aerial image, the first set of features including the first feature, the instructions to cause the logic circuit to associate the first one of the commercial characteristics with the location of interest in response to determining that the reference aerial image matches the first aerial image.

33. A storage medium as defined in claim 26, wherein the instructions are further to cause the logic circuit to identify a second feature using at least one of mapping service data, public real estate record data, traffic monitoring data, and/or mobile communications data to identify the feature.

34. A storage medium as defined in claim 33, wherein the instructions are to cause the logic circuit to identify the reference aerial image based on identifying the reference aerial image as having the second feature.

35. A storage medium as defined in claim 34, wherein the second feature comprises at least one of an urbanicity, a walkability, a driving score, or daytime employment.
